(19) United States
(12) Patent Application Publication
(10) Pub. No.: US 2025/0192843 A1
(43) Pub. Date: Jun. 12, 2025

(54) REFERENCE SIGNAL RECEIVED POWER FINGERPRINT REPORTING FOR BEAM BLOCKAGE PREDICTION

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US); Tao LUO, San Diego, CA (US)

(21) Appl. No.: 18/843,535

(22) PCT Filed: Apr. 28, 2022
(86) PCT No.: PCT/CN2022/089761

§ 371 Date: Sep. 3, 2024

(51) Int. Cl. H04B 7/06; H04B 17/318; H04L 5/00; H04W 24/10

(52) U.S. Cl. CPC H04B 7/0626; H04B 17/328; H04L 5/0051; H04W 24/10

(57) ABSTRACT

Methods, systems, and devices for wireless communications are described. A user equipment (UE) may receive channel state information (CSI) report configuration information including a first set of reference signal resource identifiers (IDs). Each reference signal resource ID may correspond to a respective reference signal resource for which respective measurement information may be included in a report for transmission to a network entity. The UE may generate the respective measurement information and transmit the report to the network entity. Based on the CSI report configuration information, the respective measurement information included in the report may correspond to respective reference signal resources that correspond to respective reference signal resource IDs of a second set of reference signal resource IDs, the second set of reference signal resource IDs being the first set of reference signal resource IDs or a subset of the first set of reference signal resource IDs.

### CROSS REFERENCE

The present Application is a 371 national phase filing of International PCT Application No. PCT/CN2022/089761 by L I et al., entitled “REFERENCE SIGNAL RECEIVED POWER FINGERPRINT REPORTING FOR BEAM BLOCKAGE PREDICTION,” filed Apr. 28, 2022, which is assigned to the assignee hereof, and which is expressly incorporated by reference in its entirety herein.

### INTRODUCTION

The following relates to wireless communications relating to reference signal received power (RSRP) reporting. Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support reference signal received power (RSRP) fingerprint reporting for beam blockage prediction. For example, the described techniques provide for efficiently measuring RSRP fingerprints while reducing reporting overhead at the UE. For example, the UE may use a measurement reporting scheme to measure and report RSRPs, signal-interference-to-noise ratios (SINRs), or other channel conditions of multiple beams, where the measurement reporting scheme may enable the UE to report measurement information for particular beams which may have or may lack strongest measurements. In some cases, the network entity may indicate specific beams (e.g., reference signal resources) to the UE to measure and include measurement information for in the report, the indication identifying a set of reference signal resource IDs corresponding to the specific beams. Alternatively, the network entity may indicate a particular (e.g., designated) set of reference signal resource IDs of multiple sets to the UE, where the UE may measure and include measurement information in the report for beams corresponding to the reference signal resources IDs in the indicated set. In some cases, the network entity may indicate multiple sets of reference signal resource IDs corresponding to beams, where the UE may select one set (e.g., the second set) from the indicated multiple sets of beams to measure and include measurement information for in the report based on one or more criteria. As such, the UE may transmit a report to the network entity indicating the measurement information of the beams corresponding to the set of reference signal resource IDs in the selected set, which may reduce signaling overhead at the UE an improve the efficiency of communications between the UE and the network entity.

A method for wireless communication at a first network node is described. The method may include receiving, from a second network node, channel state information (CSI) report configuration information including a first set of one or more reference signal resource identifiers (IDs), where each respective reference signal resource ID of the first set of one or more reference signal resource IDs corresponds to a respective reference signal resource for which respective measurement information is a candidate for inclusion in or is to be included in a report for transmission to the second network node, generating respective measurement information for each respective reference signal resource of a set of multiple reference signal resources, and transmitting, to the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDs is the first set of one or more reference signal resource IDs or is a subset of the first set of one or more reference signal resource IDs.

A first network node for wireless communication is described. The first network node may include a memory, and at least one processor coupled to the memory. The at least one processor may be configured to receive, from a second network node, CSI report configuration information including a first set of one or more reference signal resource IDs, where each respective reference signal resource ID of the first set of one or more reference signal resource IDs corresponds to a respective reference signal resource for which respective measurement information is a candidate for inclusion in or is to be included in a report for transmission to the second network node, generate respective measurement information for each respective reference signal resource of a set of multiple reference signal resources, and transmit, to the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDs is the first set of one or more reference signal resource IDs or is a subset of the first set of one or more reference signal resource IDs.

Another first network node for wireless communication is described. The first network node may include means for receiving, from a second network node, CSI report configuration information including a first set of one or more reference signal reference signal resource IDs, where each respective reference signal resource ID of the first set of one or more reference signal resource IDs corresponds to a respective reference signal resource for which respective measurement information is a candidate for inclusion in or is to be included in a report for transmission to the second network node, means for generating respective measurement information for each respective reference signal resource of a set of multiple reference signal resources, and means for transmitting, to the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDs is the first set of one or more reference signal resource IDs or is a subset of the first set of one or more reference signal resource IDs.

A non-transitory computer-readable medium having code for wireless communication stored thereon is described. The code, when executed by a first network node, may cause the first network node to receive, from a second network node, CSI report configuration information including a first set of one or more reference signal reference signal resource IDs, where each respective reference signal resource ID of the first set of one or more reference signal resource IDs corresponds to a respective reference signal resource for which respective measurement information is a candidate for inclusion in or is to be included in a report for transmission to the second network node, generate respective measurement information for each respective reference signal resource of a set of multiple reference signal resources, and transmit, to the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDs is the first set of one or more reference signal resource IDs or is a subset of the first set of one or more reference signal resource IDs.

In some aspects of the method, apparatuses, and non-transitory computer-readable medium described herein, the second set of one or more reference signal resource IDs may be the subset of the first set of one or more reference signal resource IDs, where the first set of one or more reference signal resource IDs includes a first quantity of reference signal resource IDs and the second set of one or more reference signal resource IDs includes a second quantity of reference signal resource IDs, and where the first quantity may be greater than the second quantity.

Some aspects of the method, apparatuses, and non-transitory computer-readable medium described herein may further include operations, features, means, or instructions for receiving the CSI report configuration information in radio resource control (RRC) signaling, a media access control (MAC) control element (CE) (MAC-CE), or downlink control information (DCI).

In some aspects of the method, apparatuses, and non-transitory computer-readable medium described herein, the CSI report configuration information includes a CSI resource setting associated with a CSI report setting and a CSI resource set, where the CSI resource setting includes the first set of one or more reference signal resource IDs.

Some aspects of the method, apparatuses, and non-transitory computer-readable medium described herein may further include operations, features, means, or instructions for transmitting a set of multiple reports based on the CSI report configuration information, where the set of multiple reports includes the first report, and where the second set of one or more reference signal resource IDs may be different for each respective report of the set of multiple reports.

Some aspects of the method, apparatuses, and non-transitory computer-readable medium described herein may further include operations, features, means, or instructions for receiving, from the second network node, second CSI report configuration information indicative of the second set of one or more reference signal resource IDs from the first set of one or more reference signal resource IDs.

In some aspects of the method, apparatuses, and non-transitory computer-readable medium described herein, receiving the second CSI report configuration information may include operations, features, means, or instructions for receiving the second CSI report configuration information in a MAC-CE or DCI.

In some aspects of the method, apparatuses, and non-transitory computer-readable medium described herein, the second set of one or more reference signal resource IDs may be the subset of the first set of one or more reference signal resource IDs, where the first set of one or more reference signal resource IDs includes a set of multiple subsets of one or more reference signal resource IDs, and where the subset of the first set of one or more reference signal resource IDs may be a first subset of the set of multiple subsets.

In some aspects of the method, apparatuses, and non-transitory computer-readable medium described herein, the first subset may be based on a standard deviation of respective measurement information for each reference signal resource corresponding to each reference signal resource ID from the first subset.

In some aspects of the method, apparatuses, and non-transitory computer-readable medium described herein, the first subset may be based on an RSRP change rate, an SINR change rate, or any combination thereof.

In some aspects of the method, apparatuses, and non-transitory computer-readable medium described herein, the report only includes measurement information for each respective reference signal resource of the set of multiple reference signal resources that corresponds to each respective reference signal resource ID of the first subset.

In some aspects of the method, apparatuses, and non-transitory computer-readable medium described herein, the respective measurement information included in the report includes a first measurement value corresponding to a first reference signal resource of the set of multiple reference signal resources that corresponds to a first reference signal resource ID of the second set of one or more reference signal resource IDs, and one or more respective measurement values corresponding to other reference signal resources of the set of multiple reference signal resources that corresponds to other reference signal resource IDs of the second set of one or more reference signal resource IDs, and where the one or more respective measurement values may be included in the report in an order relative to the first reference signal resource ID.

In some aspects of the method, apparatuses, and non-transitory computer-readable medium described herein, the first measurement value corresponds to a highest RSRP or SINR measurement.

In some aspects of the method, apparatuses, and non-transitory computer-readable medium described herein, the order may be in either an ascending reference signal resource ID order relative to the first reference signal resource ID or a descending reference signal resource ID order relative to the first reference signal resource ID.

In some aspects of the method, apparatuses, and non-transitory computer-readable medium described herein, the report includes, independent of a quantity of reference signal resource IDs in the second set of one or more reference signal resource IDs, a quantity of bits to represent the respective measurement information for the reference signal resources that correspond to each reference signal resource in the second set of one or more reference signal resource IDs.

In some aspects of the method, apparatuses, and non-transitory computer-readable medium described herein, a payload size of the report may be based on the quantity of the reference signal resource IDs in the second set of one or more reference signal resource IDs.

In some aspects of the method, apparatuses, and non-transitory computer-readable medium described herein, transmitting the report may include operations, features, means, or instructions for transmitting the report using one or more control channel resources or a modulation and coding scheme (MCS).

In some aspects of the method, apparatuses, and non-transitory computer-readable medium described herein, the report includes a first portion and a second portion, where the first portion includes an indication of the second set of one or more reference signal resource IDs and the second portion includes the respective measurement information, where the first portion may be fixed in size and the second portion may be variable in size.

In some aspects of the method, apparatuses, and non-transitory computer-readable medium described herein, a quantity of bits used for a payload of the report may be fixed independent of a quantity of the reference signal resource IDs of the second set of one or more reference signal resource IDs.

Some aspects of the method, apparatuses, and non-transitory computer-readable medium described herein may further include operations, features, means, or instructions for determining a quantization granularity for inclusion of the respective measurement information in the report based on the quantity of bits and the quantity of the reference signal resource IDs of the second set of one or more reference signal resource IDs.

In some aspects of the method, apparatuses, and non-transitory computer-readable medium described herein, determining the quantization granularity may include operations, features, means, or instructions for receiving an indication of one or more of the quantity of bits or an association between the quantity of bits and the quantization granularity.

In some aspects of the method, apparatuses, and non-transitory computer-readable medium described herein, the respective measurement information included in the report may be organized in a set of multiple groups, each group including a respective first reference signal resource ID of the second set of one or more reference signal resource IDs and the respective measurement information corresponding to other reference signal resource IDs of the second set of one or more reference signal resource IDs, the respective measurement information being included in the report in the set of multiple groups either in an ascending reference signal resource ID order relative to the respective first reference signal resource ID or a descending reference signal resource ID order relative to the respective first reference signal resource ID.

In some aspects of the method, apparatuses, and non-transitory computer-readable medium described herein, the groups corresponding to the second set of one or more reference signal resource IDs may be based on the CSI report configuration information or an angular separation between the reference signal resources corresponding to the reference signal resource IDs in the second set of one or more reference signal resource IDs.

In some aspects of the method, apparatuses, and non-transitory computer-readable medium described herein, the report includes a set of multiple groups, where each respective group includes a respective subset of the second set of one or more reference signal resource IDs including a respective first reference signal resource ID and a respective second reference signal ID, where the respective measurement information corresponding to each respective first reference signal resource ID in each respective group may be represented by a first quantity of bits, and where the respective measurement information corresponding to each respective second reference signal resource ID in each respective group may be represented by a second quantity of bits different from the first quantity of bits.

In some aspects of the method, apparatuses, and non-transitory computer-readable medium described herein, each respective group may be included in the report either in an ascending reference signal resource ID order relative to the respective first reference signal resource ID or a descending reference signal resource ID order relative to the respective first reference signal resource ID.

In some aspects of the method, apparatuses, and non-transitory computer-readable medium described herein, each respective reference signal resource of the one or more reference signal resources may be either a CSI-reference signal resource or a synchronization signal block (SSB) resource.

A method for wireless communication at a first network node is described. The method may include transmitting, to a second network node, CSI report configuration information including a first set of one or more reference signal reference signal reference signal resource IDs, where each respective reference signal resource ID of the one or more reference signal resource IDs corresponds to a respective reference signal resource for which respective measurement information is a candidate for inclusion in or is to be included in a report for transmission to the second network node, transmitting a set of multiple reference signals using the reference signal resources that correspond to the respective reference signal resource IDs of the first set of one or more reference signal resource IDs, and receiving, from the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDS is the first set of one or more reference signal resource IDs or is a subset of the first set of one or more reference signal resource IDs.

A first network node for wireless communication is described. The first network node may include a memory, and at least one processor coupled to the memory. The at least one processor may be configured to transmit, to a second network node, CSI report configuration information including a first set of one or more reference signal reference signal reference signal resource IDs, where each respective reference signal resource ID of the one or more reference signal resource IDs corresponds to a respective reference signal resource for which respective measurement information is a candidate for inclusion in or is to be included in a report for transmission to the second network node, transmit a set of multiple reference signals using the reference signal resources that correspond to the respective reference signal resource IDs of the first set of one or more reference signal resource IDs, and receive, from the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDS is the first set of one or more reference signal resource IDs or is a subset of the first set of one or more reference signal resource IDs.

Another first network node for wireless communication is described. The first network node may include means for transmitting, to a second network node, CSI report configuration information including a first set of one or more reference signal reference signal resource IDs, where each respective reference signal resource ID of the one or more reference signal resource IDs corresponds to a respective reference signal resource for which respective measurement information is a candidate for inclusion in or is to be included in a report for transmission to the second network node, means for transmitting a set of multiple reference signals using the reference signal resources that correspond to the respective reference signal resource IDs of the first set of one or more reference signal resource IDs, and means for receiving, from the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDS is the first set of one or more reference signal resource IDs or is a subset of the first set of one or more reference signal resource IDs.

A non-transitory computer-readable medium having code for wireless communication stored thereon is described. The code, when executed by a first network node, may cause the first network node to transmit, to a second network node, CSI report configuration information including a first set of one or more reference signal reference signal reference signal resource IDs, where each respective reference signal resource ID of the one or more reference signal resource IDs corresponds to a respective reference signal resource for which respective measurement information is a candidate for inclusion in or is to be included in a report for transmission to the second network node, transmit a set of multiple reference signals using the reference signal resources that correspond to the respective reference signal resource IDs of the first set of one or more reference signal resource IDs, and receive, from the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDS is the first set of one or more reference signal resource IDs or is a subset of the first set of one or more reference signal resource IDs.

In some aspects of the method, apparatuses, and non-transitory computer-readable medium described herein, the second set of one or more reference signal resource IDs may be the subset of the first set of one or more reference signal resource IDs, where the first set of one or more reference signal resource IDs includes a first quantity of reference signal resource IDs and the second set of one or more reference signal resource IDs includes a second quantity of reference signal resource IDs, and where the first quantity may be greater than the second quantity.

In some aspects of the method, apparatuses, and non-transitory computer-readable medium described herein, transmitting the CSI report configuration information may include operations, features, means, or instructions for transmitting the CSI report configuration information in RRC signaling, a MAC-CE, or DCI.

Some aspects of the method, apparatuses, and non-transitory computer-readable medium described herein may further include operations, features, means, or instructions for receiving a set of multiple reports based on the CSI report configuration information, where the set of multiple reports includes the first report, and where the second set of one or more reference signal resource IDs may be different for each respective report of the set of multiple reports.

In some aspects of the method, apparatuses, and non-transitory computer-readable medium described herein, the CSI report configuration information includes a CSI resource setting associated with a CSI report setting and a CSI resource set, where the CSI resource setting includes the first set of one or more reference signal resource IDs.

Some aspects of the method, apparatuses, and non-transitory computer-readable medium described herein may further include operations, features, means, or instructions for transmitting, to the second network node, second CSI report configuration information indicative of the second set of one or more reference signal resource IDS from the first set of one or more reference signal resource IDs.

In some aspects of the method, apparatuses, and non-transitory computer-readable medium described herein, transmitting the second CSI report configuration information may include operations, features, means, or instructions for transmitting the second CSI report configuration information in a MAC-CE or DCI.

In some aspects of the method, apparatuses, and non-transitory computer-readable medium described herein, the second set of one or more reference signal resource IDs may be the subset of the first set of one or more reference signal resource IDs, where the first set of one or more reference signal resource IDs includes a set of multiple subsets of one or more reference signal resource IDs, and where the subset of the first set of one or more reference signal resource IDs may be a first subset of the set of multiple subsets.

In some aspects of the method, apparatuses, and non-transitory computer-readable medium described herein, the report includes an indication of the first subset.

In some aspects of the method, apparatuses, and non-transitory computer-readable medium described herein, the first subset of one or more reference signal resource IDs may be based on a standard deviation of respective measurement information for each reference signal resource corresponding to each reference signal resource ID from the first subset.

In some aspects of the method, apparatuses, and non-transitory computer-readable medium described herein, the first subset may be based on an RSRP change rate, an SINR change rate, or any combination thereof.

In some aspects of the method, apparatuses, and non-transitory computer-readable medium described herein, the report only includes measurement information for each respective reference signal resource of the set of multiple reference signal resources that corresponds to each respective reference signal resource ID of the first subset.

In some aspects of the method, apparatuses, and non-transitory computer-readable medium described herein, the respective measurement information included in the report includes a first measurement value corresponding to a first reference signal resource of the set of multiple reference signal resources that corresponds to a first reference signal resource ID of the second set of one or more reference signal resource IDs, and one or more respective measurement values corresponding to other reference signal resources of the set of multiple reference signal resources that corresponds to a first reference signal resource ID of the second set of one or more reference signal resource IDs, and where the one or more respective measurement values may be included in the report in an order relative to the first reference signal resource ID.

In some aspects of the method, apparatuses, and non-transitory computer-readable medium described herein, the first measurement value corresponds to a highest RSRP or SINR measurement.

In some aspects of the method, apparatuses, and non-transitory computer-readable medium described herein, the order may be in either an ascending reference signal resource ID order relative to the first reference signal resource ID or a descending reference signal resource ID order relative to the first reference signal resource ID.

In some aspects of the method, apparatuses, and non-transitory computer-readable medium described herein, the report includes, independent of a quantity of reference signal resource IDs in the second set of one or more reference signal resource IDs, a quantity of bits that represents the respective measurement information for the reference signal resources that correspond to each reference signal resource in the second set of one or more reference signal resource IDs.

In some aspects of the method, apparatuses, and non-transitory computer-readable medium described herein, a payload size of the report may be based on the quantity of the reference signal resource IDs in the second set of one or more reference signal resource IDs.

In some aspects of the method, apparatuses, and non-transitory computer-readable medium described herein, receiving the report may include operations, features, means, or instructions for receiving the report using one or more control channel resources or an MCS.

In some aspects of the method, apparatuses, and non-transitory computer-readable medium described herein, the report includes a first portion and a second portion of the report, where the first portion includes an indication of the second set of one or more reference signal resource IDs and the second portion includes the respective measurement information, and where the first portion may be fixed in size and the second portion may be variable in size.

In some aspects of the method, apparatuses, and non-transitory computer-readable medium described herein, a quantity of bits used for a payload of the report may be fixed independent of a quantity of the reference signal resource IDS of the second set of one or more reference signal resource IDs.

Some aspects of the method, apparatuses, and non-transitory computer-readable medium described herein may further include operations, features, means, or instructions for transmitting an indication of one or more of the quantity of bits or an association between the quantity of bits and a quantization granularity.

In some aspects of the method, apparatuses, and non-transitory computer-readable medium described herein, the respective measurement information included in the report may be organized in a set of multiple groups, each group including a respective first reference signal resource ID of the second set of one or more reference signal resource IDs and the respective measurement information corresponding to other reference signal resource IDs of the second set of one or more reference signal resource IDs, the respective measurement information being included in the report in the set of multiple groups either in an ascending reference signal resource ID order relative to the respective first reference signal resource ID or a descending reference signal resource ID order relative to the respective first reference signal resource ID.

In some aspects of the method, apparatuses, and non-transitory computer-readable medium described herein, the groups corresponding to the second set of one or more reference signal resource IDs may be based on the CSI report configuration information or an angular separation between the reference signal resources corresponding to the reference signal resource IDs in the second set of one or more reference signal resource IDs.

In some aspects of the method, apparatuses, and non-transitory computer-readable medium described herein, the report includes a set of multiple groups, where each respective group includes a respective subset of the second set of one or more reference signal resource IDs including a respective first reference signal resource ID and a respective second reference signal ID, where the respective measurement information corresponding to each respective first reference signal resource ID in each respective group may be represented by a first quantity of bits, and where the respective measurement information corresponding to each respective second reference signal resource ID in each respective group may be represented by a second quantity of bits different from the first quantity of bits.

In some aspects of the method, apparatuses, and non-transitory computer-readable medium described herein, each respective group may be included in the report either in an ascending reference signal resource ID order relative to the respective first reference signal resource ID or a descending reference signal resource ID order relative to the respective first reference signal resource ID.

In some aspects of the method, apparatuses, and non-transitory computer-readable medium described herein, each respective reference signal resource of the one or more reference signal resources may be either a CSI-reference signal resource or an SSB resource.

### BRIEF DESCRIPTION OF THE DRAWINGS

FIG. 1 illustrates an example of a wireless communications system that supports reference signal received power (RSRP) fingerprint reporting for beam blockage prediction in accordance with one or more aspects of the present disclosure.

FIG. 2 illustrates an example of a wireless communications systems that supports RSRP fingerprint reporting for beam blockage prediction in accordance with one or more aspects of the present disclosure.

FIGS. 3 and 4 illustrate examples of report formats that support RSRP fingerprint reporting for beam blockage prediction in accordance with one or more aspects of the present disclosure.

FIG. 5 illustrates an example of a process flow that supports RSRP fingerprint reporting for beam blockage prediction in accordance with one or more aspects of the present disclosure.

FIGS. 6 and 7 show block diagrams of devices that support RSRP fingerprint reporting for beam blockage prediction in accordance with one or more aspects of the present disclosure.

FIG. 8 shows a block diagram of a communications manager that supports RSRP fingerprint reporting for beam blockage prediction in accordance with one or more aspects of the present disclosure.

FIG. 9 shows a diagram of a system including a device that supports RSRP fingerprint reporting for beam blockage prediction in accordance with one or more aspects of the present disclosure.

FIGS. 10 and 11 show block diagrams of devices that support RSRP fingerprint reporting for beam blockage prediction in accordance with one or more aspects of the present disclosure.

FIG. 12 shows a block diagram of a communications manager that supports RSRP fingerprint reporting for beam blockage prediction in accordance with one or more aspects of the present disclosure.

FIG. 13 shows a diagram of a system including a device that supports RSRP fingerprint reporting for beam blockage prediction in accordance with one or more aspects of the present disclosure.

FIGS. 14 through 19 show flowcharts illustrating methods that support RSRP fingerprint reporting for beam blockage prediction in accordance with one or more aspects of the present disclosure.

### DETAILED DESCRIPTION

Some wireless communications systems may support wireless communications between network nodes, such as a user equipment (UE) (e.g., a first network node) and a network entity (e.g., a second network node). For example, a network entity may transmit reference signals to the UE via one or more beams. In some aspects, a UE may measure channel conditions of a reference signal (e.g., a synchronization signal block (SSB) or a channel state information reference signal (CSI-RS)) to determine which one or more beams may be best for communications between the UE and the network entity based on having a highest or strongest measurement. Accordingly, the network entity may transmit the reference signals on multiple different beams while relying on the UE to measure each of the beams and report one or more beam identifiers (IDs) corresponding to the one or more strongest beams to be used by the network entity. However, the network entity may additionally transmit the reference signals to sense the wireless communications system (e.g., environment) and predict if a beam blockage may occur. This sensing may be referred to as reference signal received power (RSRP) fingerprinting, in which a UE may measure multiple beams and instead of reporting just the beams with highest measurements, the UE may report measurements for many beams, effectively creating an overall fingerprint of the environment between the network entity and the UE. Reporting RSRP measurements for all beams in an RSRP fingerprinting scenario, however, may result in an increased overhead (e.g., increased power consumption, increased resource consumption) at the UE.

Techniques described herein enable a UE to efficiently measure RSRP fingerprints while reducing reporting overhead at the UE. For example, the UE may use a measurement reporting scheme to measure and report RSRPs, signal-interference-to-noise ratios (SINRs), or other channel conditions of multiple beams, where the measurement reporting scheme may enable the UE to report measurement information for particular beams which may have or may lack strongest measurements. In some cases, the network entity may indicate specific beams (e.g., reference signal resources) to the UE to measure and include measurement information for in the report, the indication identifying a set of reference signal resource IDs corresponding to the specific beams. Alternatively, the network entity may indicate a particular (e.g., designated) set of reference signal resource IDs of multiple sets to the UE, where the UE may measure and include measurement information in the report for beams corresponding to the reference signal resources IDs in the indicated set. In some aspects, the network entity may indicate multiple sets of reference signal resource IDs corresponding to beams, where the UE may select one set (e.g., the second set) from the indicated multiple sets of beams to measure and include measurement information for in the report based on one or more criteria. As such, the UE may transmit a report to the network entity indicating the measurement information of the beams corresponding to the set of reference signal resource IDs in the selected set, which may reduce signaling overhead at the UE an improve the efficiency of communications between the UE and the network entity.

Aspects of the subject matter described herein may be implemented to realize one or more of the following potential improvements, among others. The techniques employed by the described network nodes (e.g., UEs, network entities) may enable RSRP fingerprint reporting for beam blockage prediction, which may enable a network entity to more accurately predict beam blockages. For example, by enabling a UE to report measurement information for specific beams (e.g., reference signal resources) instead of measurement information for only particular beams with highest measurements (e.g., strongest RSRPs, SINRs), the network nodes may reduce signaling overhead and subsequently increase power savings as the report may indicate a more accurate RSRP fingerprint of the environments. In addition, reporting more accurate RSRP fingerprints in this way may enable the network entity to better predict beam blockages, which may reduce the chance of failed or dropped transmissions and increase the quality of communications between the network entity and the UE.

Aspects of the disclosure are initially described in the context of wireless communications systems. Aspects of the disclosure are then described in the context of report formats in process flows. Aspects of the disclosure are further illustrated by and described with reference to apparatus diagrams, system diagrams, and flowcharts that relate to RSRP fingerprint reporting for beam blockage prediction.

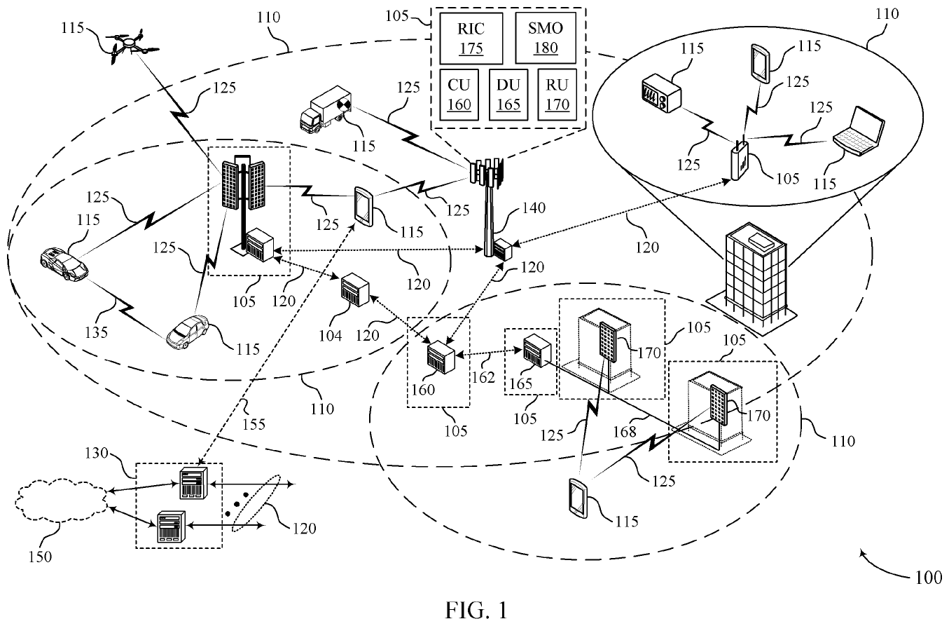

FIG. 1 illustrates an example of a wireless communications system 100 that supports RSRP fingerprint reporting for beam blockage prediction in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another over a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, media access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support RSRP fingerprint reporting for beam blockage prediction as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some aspects, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some aspects, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some aspects, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be able to communicate directly with other UEs 115 over a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some aspects, one or more UEs 115 in such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some aspects, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some aspects, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

In some cases, a network entity 105 (e.g., a network node) may transmit reference signals (e.g., SSBs, CSI-RSs) to a UE 115 (e.g., a network node) via one or more beams (e.g., relatively wide, layer 1 (L1) beams). In some aspects, the UE 115 may perform measurements on the beams to determine which beams are best suited for communications between the network entity 105 and the UE 115. In addition, the UE 115 may determine one or more receive beams for receiving transmissions from the network entity 105. In some cases, the UE 115 may detect a beam failure, in which case the UE 115 may perform some beam refinement procedure. For example, the UE 115 may perform a beam failure (e.g., radio link) recovery operation to recover communications with the network entity 105. Additionally, or alternatively, the UE 115 may request different beams from the network entity 105, or the UE 115 may perform a radio link failure operation. In some aspects, a UE 115 may perform a beam measurement operation (e.g., or another beam management operation) to facilitate beam predictions in the time domain, the spatial domain, or both, which may reduce signaling overhead and latency and improve beam selection accuracy. For example, by predicting a beam failure before measuring the beam, the UE 115 may reduce its own beam measurement and beam sweeping efforts.

A UE 115 may use RSRP fingerprints for beam blockage prediction. RSRP fingerprints may represent a time series of RSRP (e.g., L1-RSRP) measurements associated with spatially swept beams (e.g., network entity 105 transmit beams). The network entity 105 may use such RSRP fingerprints to train machine learning models for predicting beam blockage, including predicting a beam blockage event and a corresponding instance, severity, and direction, among other information. By training the machine learning models using RSRP fingerprints, the network entity 105 may associate (e.g., label) actual beam failure instances with corresponding beam IDs (e.g., indices, indicators), which may improve the accuracy of beam blockage predictions. For example, if the RSRP fingerprint indicates a future period of time in which a set of beams may be entirely blocked, the RSRP fingerprint may indicate jittering (e.g., inconsistencies) before the blockage instance, which may trigger the prediction of the upcoming beam blockage.

A network entity 105 may transmit a set of beams (e.g., SSB resources, CSI-RS resources) in different directions, which the UE 115 may receive via one or more receive beams. The UE 115 may periodically measure and report measured RSRPs associated with the set of beams transmitted in different directions (e.g., spatially swept SSB or CSI-RS resources). The network entity 105 may use a machine learning model (e.g., a recurrent neural network (RNN) model) to predict beam blockage using, where the machine learning model may be trained using the reported RSRPs. In this way, the network entity 105 may use the machine learning model to predict beam blockage in future time periods. In some aspects, the UE 115 may report the strongest measured RSRPs to the network entity 105. For example, the UE 115 may measure and report the measurements of up to the four strongest SSB beams or CSI-RS beams transmitted by the network entity 105, which may fail to efficiently and accurately reflect the characteristics of an RSRP fingerprint (e.g., as only the strongest measurements are included). However, reporting every measuring and reporting RSRPs for every beam may result in increased overhead consumption at the UE 115 (e.g., increased power and resource usage).

The wireless communications system 100 may support improved RSRP fingerprint reporting for beam blockage prediction, which may enable a UE 115 to more efficiently report RSRP fingerprints to a network entity 105 while reducing signaling and power overhead. For example, the UE 115 may use measurement (e.g., RSRP) reporting schemes where the UE 115 may report measured channel characteristics (e.g., RSRPs, SINRs) of beams (e.g., reference signal resources) that may have or lack the strongest measurements. That is, which measurement information the UE 115 reports may be based on a configuration indicated from the network entity 105, a dynamic indication from the network entity 105, or a determination by the UE 115. By reporting measurement information of various beams (e.g., instead of just for the beams with strongest or highest measurements), the UE 115 may more efficiently and accurately report an RSRP fingerprint of an environment of the wireless communications system 100, which may enable the network entity 105 to more accurately predict beam blockages. In addition, signaling and power consumption at the UE 115 may be further reduced as the UE 115 and the network entity 105 may use variable payload sizes or variable quantization granularities when measuring and reporting the measurements.

In some cases, the network entity 105 may indicate specific beams (e.g., reference signal resources) to a UE 115 to measure and include measurement information for in the report, the indication identifying a set of reference signal resource IDs corresponding to the specific beams. Alternatively, the network entity 105 may indicate a particular (e.g., designated) set of reference signal resource IDs of multiple sets to the UE 115, where the UE 115 may measure and include measurement information in the report for beams corresponding to the reference signal resources IDs in the indicated set. In some aspects, the network entity 105 may indicate multiple sets of reference signal resource IDs corresponding to beams, where the UE 115 may select one set (e.g., the second set) from the indicated multiple sets of beams to measure and include measurement information for in the report based on one or more criteria. As such, the UE 115 may transmit a report to the network entity 105 indicating the measurement information of the beams corresponding to the set of reference signal resource IDs in the selected set, which may reduce signaling overhead at the UE 115 an improve the efficiency of communications between the UE 115 and the network entity 105.

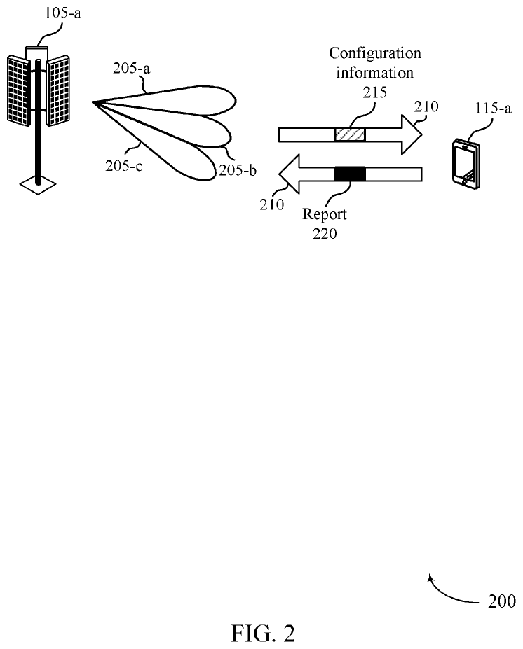

FIG. 2 illustrates an example of a wireless communications system 200 that supports RSRP fingerprint reporting for beam blockage prediction in accordance with one or more aspects of the present disclosure. The wireless communications system 200 may implement or be implemented by aspects of the wireless communications system 100 described with reference to FIG. 1. For example, the wireless communications system 200 may include a UE 115-a (e.g., a first network node) and a network entity 105-a (e.g., a second network entity), which may be examples of the corresponding devices described with reference to FIG. 1. The wireless communications system 200 may support improved RSRP fingerprint reporting, which may support improved communications between the network entity 105-a and the UE 115-a. For example, the wireless communications system 200 may support increased signaling efficiency and reduced power and resource overhead, among other benefits.

The wireless communications system 200 may support communications between the network entity 105-a and the UE 115-a. For example, the network entity 105-a may communicate signals with the UE 115-a over respective communication links 210, which may be an example of a communication link 125 described with reference to FIG. 1. In some cases, the network entity 105-a may transmit one or more reference signals (e.g., SSBs, CSI-RSs) to the UE 115-a via one or beams 205, where each reference signal may be associated with a reference signal resource ID (e.g., index). In some aspects, transmitting the reference signals may enable the network entity 105-a to sense its environment (e.g., in the wireless communications system 200) and predict whether a beam blockage may occur. In addition, the UE 115-a may measure an RSRP or other channel characteristic of one or more of the beams 205 and report the measurement information to the network entity 105-a. For example, the UE 115-a may measure and report RSRPs of particular beams 205 to develop an RSRP fingerprint, and the network entity 105-a may use the RSRP fingerprint to predict beam blockages.

In some aspects, the UE 115-a may receive CSI report configuration information 215 that includes a first set of one or more reference signal resource IDs, each reference signal resource ID of the one or more reference signal resource IDs corresponding to a respective reference signal resource (e.g., a respective) beam 205. That is, a beam 205 may be associated with a CSI-RS resource or an SSB resource. As such, the CSI report configuration information 215 may identify one or more sets of CSI or SSB resource IDs, where each respective reference signal resource ID in the first set may correspond to a respective reference signal resource for which respective measurement information may be included in a report 220 (e.g., a CSI report) for transmission to the network entity 105-a. For example, the respective reference signal resource IDs may correspond to a beam 205-a, a beam 205-b, and a beam 205-c.

The CSI report configuration information 215 may refer to or include a CSI report setting (e.g., an RRC configuration) associated with the first set of one or more reference signal resource IDs and corresponding beams 205 (e.g., corresponding reference signal resources). The CSI report setting may configure the UE 115-a to measure channel characteristics of one or more beams 205 associated with the first set of reference signal resource IDs, where the channel characteristics may include one or more of an RSRP (e.g., an L1-RSRP), an SINR (e.g., an L1-SINR), a rank indicator (RI), a precoding matrix indicator (PMI), an LI, and a channel quality indicator (CQI), among other channel characteristics. That is, the CSI report configuration information 215 may include the CSI report setting associated with a CSI report setting and a CSI resource set, where the CSI resource setting may include the first set of one or more reference signals resource IDs. Which beams 205 the UE 115-a addresses in the report 220 may be based on a configuration by the network entity 105-a (e.g., an RRC configuration), a dynamic indication from the network entity 105-a (e.g., via downlink control information (DCI) or a MAC control element (MAC-CE), or may be determined proactively by the UE 115-a.

In some cases, the network entity 105-a may configure the first set of one or more reference signal resource IDs and indicate the first set to the UE 115-a. For example, the CSI report configuration information 215 may identify a single set of reference signal resource IDs corresponding to beams 205 for which respective measurement information may be included in the report 220. The network entity 105-a may include the single, first set in the CSI report setting in the CSI report configuration information 215. That is, the first set of one or more reference signal resource IDs may be configured in the CSI report setting. Alternatively, the first set of one or more reference signal resource IDs may be configured in a CSI resource setting (e.g., configuration) associated with the CSI report setting and the first set of one or more reference signal resource IDs. The UE 115-a may determine the first set from the CSI resource setting associated with the CSI report configuration information 215. In some cases, the first set of one or more reference signal resource IDs may vary across different reporting instances (e.g., in a round robin manner).

Alternatively, the network entity 105-a may indicate the first set of one or more reference signal resource IDs to the UE 115-a (e.g., via a dynamic indication), for example, to refine the first set. In some cases, the UE 115-a may receive second CSI report configuration information from the network entity 105-a indicating a second set of one or more reference signal resource IDs from the first set of one or more reference signal reference signal resource IDs identified in the CSI report configuration information 215. The network entity 105-a may transmit the second CSI report configuration information in a MAC-CE or DCI. In some aspects, the second CSI report configuration information may include a CSI trigger state that corresponds to a set of reference signal resource IDs identified in the CSI report setting of the CSI report configuration information 215. For example, the network entity 105-a may dynamically indicate the first set of one or more reference signal resource IDs based on indicating the CSI trigger state (e.g., via a CSI trigger or activation state ID) associated with the CSI report setting indicated in the MAC-CE or DCI, where different CSI trigger states may include different sets of one or more reference signal resource IDs (for which respective measurement information may be included in the report 220). The network entity 105-a may indicate the first set of one or more reference signal resource IDs based on the CSI report setting including multiple options for the first set of reference signal resource IDs and based on the different CSI triggering states corresponding to different option IDs or combinations of option IDs.

Based on the network entity 105-a configuring the first set of one or more reference signal resource IDs or transmitting the second CSI report configuration information indicating the first set, the UE 115-a may refrain from including measurement information for each beam 205 associated with each reference signal resource ID in each set of reference signal resource IDs indicated in the CSI report configuration information 215. That is, because the network entity 105-a may fully control which respective measurement information for which beams 205 may be included in the report 220, the UE 115-a may include respective measurement information in the report 220 only for the beams 205 that correspond to the first set.

In some cases, the UE 115-a may proactively determine the second set of reference signal resource IDs. For example, the UE 115-a may receive the CSI report configuration information 215 from the network entity 105-a identifying the one or more sets of reference signal resource IDs, and the UE 115-a may select the second set from among the one or more sets received in the CSI report configuration information 215 such that the UE 115-a may measure the channel characteristics of the beams 205 associated with the second set. In addition to including the measurements of the beams 205 that correspond to the reference signal resource IDs of the second set in the report 220, the UE 115-a may include an indication of the second set (e.g., the selected association option ID). In this way, the report 220 may indicate measured channel characteristics associated with the beams 205 and may indicate the corresponding reference signal resource IDs of the second set.

In some aspects, the UE 115-a may determine to include measurement information in the report 220 for particular reference signal resources (e.g., beams 205) based on one or more criteria. For example, the UE 115-a may generate respective measurement information for each respective reference signal resource of multiple reference signal resources. The UE 115-a may transmit the report 220 to the network entity 105-a. Based on the CSI report configuration information 215, the respective measurement information corresponding to each respective reference signal resource of the multiple reference signal resources that corresponds to each respective reference signal resource ID of a second set of one or more reference signal resource IDs. The second set of one or more reference signal resource IDs may be the first set of one or more reference signal resource IDs, for example, in the case where the network entity 105-a configures or dynamically indicates the first set). Alternatively, the second set of one or more reference signal resource IDs may be a subset of the first set of one or more reference signal resource IDs, in which case the UE 115-a may determine the subset based on the one or more criteria. For example, if the second set of one or more reference signal resource IDs is the subset of the first set of one or more reference signal resource IDs included in the CSI report configuration information 215, the second set of one or more reference signal resource IDs may include a quantity of reference signal resource IDs that is smaller than a quantity of reference signal resource IDs included in the first set of one or more reference signal resource IDs.

The UE 115-a may include measurement information in the report 220 for the second set of reference signal resource IDs based on a standard deviation of measurement information on beams 205 that correspond to respective reference signal resource IDs of the second set of reference signal resource IDs, an RSRP change rate, an SINR change rate, or any combination thereof. For example, the UE 115-a may select the second set of one or more reference signal resource IDs such that the second set includes reference signal resource IDs that correspond to beams 205 having a largest standard deviation of the measurements on the beams 205. Additionally, or alternatively, the UE 115-a may select the second set such that the reference signal resource IDs of second set correspond to beams 205 having a greatest RSRP change (e.g., improving or dropping) rate, a greatest SINR change (e.g., improving or dropping) rate, or both, where the RSRP and SINR change rates may be based on averaged overall measurement information all of the measured beams 205 or based on the strongest (e.g., highest) measurement information of the measured beams 205.

In some aspects, the respective measurement information included in the report 220 may include a first measurement value corresponding to a first reference signal resource (e.g., the beam 205-a) that corresponds to a first reference signal resource ID of the second set of one or more reference signal resource IDs. The first measurement value may correspond to a highest (e.g., strongest) RSRP or SINR measurement of all of the reference signal resources measured. In addition, the measurement information included in the report 220 may include one or more additional respective measurement values corresponding to other reference signal resources (e.g., the beam 205-b, the beam 205-c) that correspond to other reference signal resource IDs of the second set of one or more reference signal resource IDs. The additional measurement values may be included in the report 220 in an order relative to the first reference signal resource ID. For example, the order may be in an ascending reference signal resource ID order relative to the first reference signal resource ID, or in a descending reference signal resource ID order relative to the first reference signal resource ID. In some aspects, the report 220 may indicate a respective reference signal resource ID in association with corresponding measurement information. That is, the UE 115-a may indicate which reference signal resource (e.g., beam 205) is associated with which measurement information using the respective reference signal resource IDs corresponding to the reference signal resources.

The second set of one or more reference signal resource IDs may be different across different reporting instances (e.g., in a round robin manner). The UE 115-a may transmit multiple reports including the report 220 (e.g., a first report) based on the CSI report configuration information 215, where the second set of one or more reference signal resource IDs is different for each respective report of the multiple reports. For example, the UE 115-a may include measurement information for the beam 205-a, the beam 205-b, and the beam 205-c in the report 220, and may include different measurement information for a different set of one or more beams 205 in the other respective reports.

In some cases, the UE 115-a may differentially quantize any non-strongest RSRP or SINR measurement information with reference to highest measurement information (e.g., a strongest, highest measurement) for inclusion in the report 220. To improve reporting efficiency and decrease signaling overhead at the UE 115-a, the UE 115-a may further group the measurements in the report 220 such that the UE 115-a may report a reference signal resource ID associated with the highest measurement information within each group. In this way, the UE 115-a may include, in a group of the report 220, the highest measurement information (e.g., an absolute value of the highest measurement) using a first quantization granularity (e.g., 7 bits per measurement value), and remaining measurement information corresponding to additional reference signal resource IDs in the group differentially using a second quantization granularity (e.g., 2 bits per measurement value) with reference to the highest measurement information. The UE 115-a may include the remaining measurement information in the group in an ascending ID order or a descending ID order. As such, the UE 115-a may organize the measurements to be included in the report into multiple groups, each group including a respective first reference signal resource ID of the second set of one or more reference signal resource IDs and one or more respective measurement values corresponding to other reference signal resource IDs of the second set, the one or more respective measurement value being included in the report in an ascending or descending order relative to the respective first reference signal resource ID.

In some aspects, the UE 115-a may determine the multiple groups explicitly or implicitly. For example, the UE 115-a may receive the CSI report configuration information 215 from the network entity 105-a and determine the groups explicitly based on the CSI report configuration information 215, for example by determining which reference signal resource IDs the UE 115-a may group together. Additionally, or alternatively, the UE 115-a may form the groups implicitly according to an angular separation between the beams 205 in the second set. For example, the network entity 105-a may indicate to the UE 115-a leading reference signal resource IDs (e.g., a first reference signal resource ID corresponding to a beam 205 having the highest measurement information) within each group, where the UE 115-a may determine which remaining reference signal resource IDs to include in the group based on which corresponding beams 205 have a smallest difference in beam point direction in the azimuth and elevation angles from the leading reference signal resource IDs. The network entity 105-a may separately signal the beam point directions of the reference signal resource IDs in the second set to the UE 115-a. The UE 115-a may differentially quantize the remaining measurements (e.g., corresponding to the remaining reference signal resource IDs) with reference to the highest measurement information to be included in the report 220 in addition to grouping the reference signal resource IDs in the second set for inclusion in the report 220. For example, the network entity 105-a may configure both options, while one option may be considered as a default for periodic, semi-persistent, or aperiodic reports, activated or triggered for semi-persistent or aperiodic reports, dynamically changed for semi-persistent reports, or any combination thereof.

Using the techniques described herein, the UE 115-a may transmit the report 220 to the network entity 105-a including the measurements information, effectively indicating an RSPR fingerprint of the communications between the network entity 105-a and the UE 115-a using more than just measurement information corresponding to strongest measured RSRPs or SINRs for some beams 205. As such, the network entity 105-a may use the reported measurement information to more accurately predict beam blockages, which may result in fewer failed beams and transmissions and overall improved communications between the network entity 105-a and the UE 115-a.

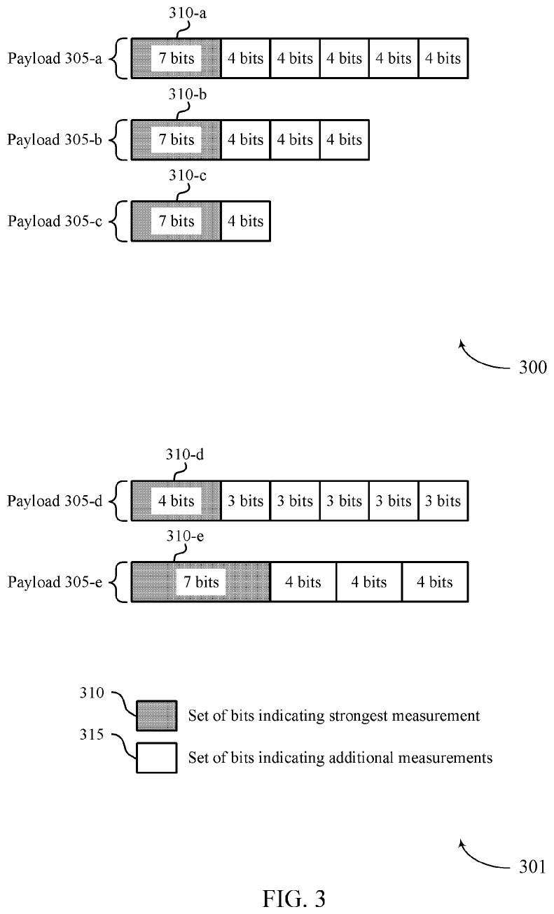

FIG. 3 illustrates an example of a report format 300 and a report format 301 that supports RSRP fingerprint reporting for beam blockage prediction in accordance with one or more aspects of the present disclosure. The report formats 300 and 301 may implement or be implemented by aspects of the wireless communications systems 100 and 200 described with reference to FIGS. 1 and 2, respectively. For example, a UE (e.g., a first network node) may transmit a report to a network entity (e.g., a second network node) using the report format 300 or the report format 301, where the report may include measurements information for reference signal resources (e.g., CSI-RS beams, SSB beams) corresponding to reference signal resource IDs of a set of reference signal resource IDs.

In some aspects, the UE may receive CSI report configuration information that includes a first set of reference signal resource IDs, each reference signal resource ID corresponding to a reference signal resource (e.g., an SSB beam, a CSI-RS beam), and each set of reference signal resource IDs corresponding to reference signal resources for which respective measurement information may be included in a report (e.g., a CSI report) for transmission to the network entity. The UE may generate respective measurement information for each respective reference signal resource of multiple reference signal resources. In some aspects, the UE may determine which respective reference signal resources to include measurement information for based on a configuration from the network entity, a dynamic indication from the network entity, or one or more criteria. In addition, the measurement information may include measured channel characteristics of the reference signal resources such as RSRPs and SINRs, among other channel characteristics. The UE may transmit the report to the network entity, where, based on the CSI report configuration information, the respective measurement information corresponding to each respective resource may correspond to respective reference signal resource IDs of a second set of one or more reference signal resource IDs. The second set may be the first set, or may be a subset of the first set (e.g., as determined by the UE). The UE may include and organize the respective measurement information in the report in accordance with the report format 300 or the report format 301.

As identified in the CSI report configuration information, the first set of reference signal resource IDs may include different quantities of reference signal resources IDs corresponding to reference signal resources (e.g., CSI beams, SSB beams). Based on the variable sizes of the sets of reference signal resource IDs, the UE may use the report format 300 or the report format 301 to indicate the respective measurement information associated with respective reference signal resource IDs. For example, the UE may use the report format 300 to utilize a variable payload size with a fixed quantization granularity (e.g., a quantity of bits used to indicate each quantized RSRP measurement, SINR measurement, step-size, dynamic range, or other measurements).

In some cases, the report format 300 may include a payload 305-a, a payload 305-b, and a payload 305-c, where there UE may use each payload 305 to transmit the report. Despite a total quantity of reference signal resources the UE may address in the report, the quantity of bits used to indicate each quantized RSRP or SINR measurement value in a payload 305 may remain the same. That is, independent of a quantity of reference signal resource IDs included in the second set of reference signal resource IDs, the UE may include a predetermined quantity of bits in the report to represent each of the measurements (e.g., RSRP measurements, SINR measurements, and the like) on the reference signal resources that correspond to the reference signal resource IDs of the second set. In addition, the UE may use a variable payload size to transmit the report including the measurements of the reference signal resources, where the payload size is varied based on a total quantity of reference signal resource IDs to be included (e.g., addressed) in the report. In some cases, the UE may identify one or more control channel (e.g., PUCCH) resources, a modulation and coding scheme (MCS), or both according to the variable payload size.

Each payload 305 may include a set of bits 310 used to indicate a highest (e.g., strongest) measurement value of a first reference signal resource ID and one or more sets of bits 315 used to indicate one or more additional measurement values of one or more reference signal resource IDs. As each payload 305 has a fixed quantization granularity, each set of bits 310 may include 7 bits and each set of bits 315 may include 4 bits. The payload 305-a may include a set of bits 310-a and five sets of bits 315, which may result in a total payload size of 27 bits. The set of bits 310-a may indicate the highest measurement value corresponding to the first reference signal resource ID of the second set, and the multiple sets of bits 315 may indicate a respective measurement value corresponding to five additional reference signal resource IDs of the second set.

The payload 305-b may include a set of bits 310-b and three sets of bits 315, which may result in a total payload size of 19 bits. The set of bits 310-b may indicate the highest (e.g., strongest) measurement value corresponding to the first reference signal resource ID of the second set, and each set of bits 315 may indicate a respective measurement value corresponding to three additional reference signal resource IDs in the second set. In addition, the payload 305-c may include a set of bits 310-c and one set of bits 315, which may result in a total payload size of 11 bits. The set of bits 310-c may indicate the highest measurement value corresponding to the first reference signal resource ID of the second set, and the set of bits 315 may indicate a respective measurement value corresponding to an additional reference signal resource ID in the second set. In this way, the payload 305-a, the payload 305-b, and the payload 305-c may have variable payload sizes (e.g., 27 bits, 19 bits, and 11 bits, respectively) and a same quantization granularity (e.g., 7 bits for the sets of bits 310, 4 bits for the sets of bits 315). It should be noted that the payloads 305 may include different quantities of bits than as described herein.

Alternatively, the UE may utilize the report format 301 to utilize a fixed payload size and a variable quantization granularity. In some aspects, the report format 301 may include a payload 305-d and a payload 305-e, which the UE may use to transmit the report. Despite a total quantity of reference signal resources IDs the UE may include in the report, the UE may use a same total quantity of bits in each payload 305. That is, the payload size of each payload 305 of the report may remain the same independent of a quantity of the reference signal resource IDs included in the second set. In addition, a quantization granularity may vary depending on the total quantity of bits in each payload 305 and the quantity of reference signal resource IDs included in the report. For example, the total quantity of bits used to indicate each quantized RSRP measurement value or each quantized SINR measurement value in a payload 305 may vary.

In some aspects, the UE may determine a quantization granularity for including the measurements in the report based on a quantity of bits allocated to each payload 305 and the quantity of reference signal resource IDs in the second set. Alternatively, the network entity may configure multiple quantization granularity options, each option associated with the total quantity of bits allocated to each payload 305 to transmit the report and the total quantity of reference signal resource IDs in the second set. The UE may receive an indication of the one or more options (e.g., one or more of the quantity of bits or an association between the quantity of bits and the quantization granularity) from the network entity and determine the quantization granularity for each of the payloads 305 based on the indication. As such, which quantization granularity is used for indicating measurement values corresponding to particular reference signal resource IDs may be based on a configuration or indication from the network entity, or may be based on a determination by the UE. In addition, the network entity may configure or dynamically change the total quantity of bits for transmitting the report in the payloads 305.

The payload 305-d and the payload 305-e may each include a set of bits 310 to indicate a highest (e.g., strongest) measurement value of a first reference signal resource ID and one or sets of bits 315 to indicate one or more additional measurement values of one or more reference signal resource IDs. As each payload 305 has a fixed payload size, each payload 305 may include a total of 19 bits, however each set of bits 310 and each set of bits 315 may include different quantities of bits. For example, the payload 305-d may include a set of bits 310-d that includes 4 bits used to indicate the highest measurement value corresponding to the first reference signal resource ID of the second set. Additionally, the payload 305-d may include five sets of bits 315 each including 3 bits used to indicate a respective measurement value corresponding to five additional reference signal resource IDs of the second set.

Additionally, the payload 305-e may include a set of bits 310-e and three sets of bits 315, which may result in a total payload size of 19 bits. The payload 305-e may include the set of bits 310-e that includes 7 bits used to indicate the highest (e.g., strongest) measurement value corresponding to the first reference signal resource ID of the second set. In addition, the payload 305-e may include three sets of bits 315 each including 4 bits used to indicate a respective measurement value corresponding to five additional reference signal resource IDs of the second set. In this way, the payload 305-d and the payload 305-e may have fixed payload sizes (e.g., 19 bits) and variable quantization granularities (e.g., the set of bits 310-d in the payload 305-d may include 4 bits while the set of bits 310-e in the payload 305-e may include 7 bits, and the sets of bits 315 in the payload 305-d may each include 3 bits while the sets of bits 315 in the payload 305-e may each include 4 bits). It should be noted that the payloads 305 may include different quantities of bits than as described herein.

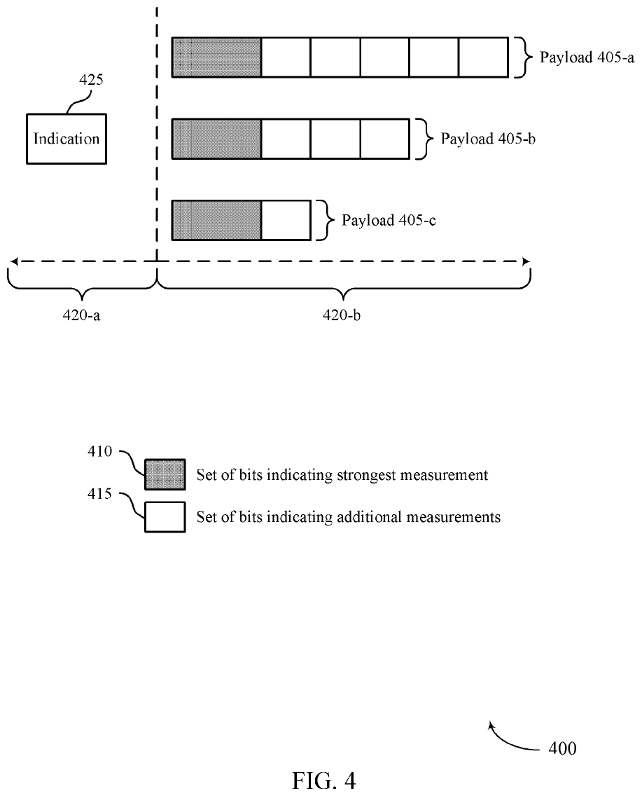

FIG. 4 illustrates an example of a report format 400 that supports RSRP fingerprint reporting for beam blockage prediction in accordance with one or more aspects of the present disclosure. The report format 400 may implement or be implemented by aspects of the wireless communications systems 100 and 200 described with reference to FIGS. 1 and 2, respectively. For example, a UE (e.g., a first network node) may transmit a report to a network entity (e.g., a second network node) using the report format 400, where the report may include measurements information for reference signal resources (e.g., CSI-RS beams, SSB beams) corresponding to reference signal resource IDs of a set of reference signal resource IDs.

In some aspects, the UE may receive CSI report configuration information that includes a first set of reference signal resource IDs, each reference signal resource ID corresponding to a reference signal resource (e.g., an SSB beam, a CSI-RS beam), and each set of reference signal resource IDs corresponding to reference signal resources for which respective measurement information may be included in a report (e.g., a CSI report) for transmission to the network entity. The UE may generate respective measurement information for each respective reference signal resource of multiple reference signal resources. In some aspects, the UE may determine which respective reference signal resources to include measurement information for based on a configuration from the network entity, a dynamic indication from the network entity, or one or more criteria. In addition, the measurement information may include measured channel characteristics of the reference signal resources such as RSRPs and SINRs, among other channel characteristics. The UE may transmit the report to the network entity, where, based on the CSI report configuration information, the respective measurement information corresponding to each respective resource may correspond to respective reference signal resource IDs of a second set of one or more reference signal resource IDs. The second set may be the first set, or may be a subset of the first set (e.g., as determined by the UE). The UE may include and organize the respective measurement information in the report in accordance with the report format 400.

As identified in the CSI report configuration information, the first set of reference signal resource IDs may include different quantities of reference signal resources IDs corresponding to reference signal resources (e.g., CSI beams, SSB beams). Based on the variable sizes of the sets of reference signal resource IDs, the UE may use the report format 400 to indicate respective measurement information associated with respective reference signal resource IDs. For example, the UE may use the report format 400 to utilize a variable payload size with a fixed quantization granularity (e.g., a quantity of bits used to indicate each quantized RSRP measurement, SINR measurement, step-size, dynamic range, or other measurements).

In some cases, the report format 400 may include a payload 405-a, a payload 405-b, and a payload 405-c, where there UE may use each payload 405 to transmit the report. Despite a total quantity of reference signal resources the UE may address in the report, the quantity of bits used to indicate each quantized RSRP measurement value or each quantized SINR measurement value in a payload 405 may remain the same. That is, independent of a quantity of reference signal resource IDs included in the second set of reference signal resource IDs, the UE may include a predetermined quantity of bits in the report to represent each of the measurements on the reference signal resources that correspond to the reference signal resource IDs of the second set. In addition, the UE may use a variable payload size to transmit the report including the measurements of the reference signal resources, where the payload size of each payload 405 may vary based on a total quantity of reference signal resource IDs to be included (e.g., addressed) in the report.

In some cases, the payloads 405 may include bits indicating the measurement information for the reference signal resources corresponding to the second set. For example, each payload 405 may include a set of bits 410 to indicate a highest measurement value of a first reference signal resource ID and one or more sets of bits 415 to indicate one or more additional measurement values of one or more reference signal resources corresponding to one or more reference signal resource IDs. As each payload 405 has a fixed quantization granularity, each set of bits 410 may include a same quantity of bits (e.g., 7 bits) and each set of bits 415 may include a same quantity of bits (e.g., 4 bits). Additionally, as each payload 405 has a variable payload size, the payload 405-a may include five sets of bits 415, the payload 405-b may include three sets of bits 415, and the payload 405-c may include one set of bits 415, each in addition to one set of bits 410. As such, the payload 405-a may have a larger payload size (e.g., include more bits) than the payload 405-b, and the payload 405-b may have a larger payload size than the payload 405-c. It should be noted that the payloads 405 may include different quantities of bits than those described herein.

In addition to indicating the measurement values of the reference signal resources corresponding to reference signal resource IDs in the second set, the UE may indicate corresponding reference signal resource IDs in the report. For example, the UE may transmit the report (e.g., a CSI report) in two portions according to the report format 400, where the UE transmits the report via a shared channel (e.g., a PUSCH). In some cases, the report may include a first portion 420-a and a second portion 420-b. As such, the UE may transmit an indication of the second set 425 in the first portion 420-a of the report and the payloads 405 (e.g., the measurements) in the second portion 420-b of the report, where the first portion 420-a is fixed in size and the second portion 420-b is variable in size based on the variable sizes of the payloads 405.

In some cases, the UE may identify one or more control channel (e.g., PUCCH) resources, an MCS, or both according to the variable payload size. The UE may transmit the report via the control channel and using the MCS, and the network entity may use blind detection or decoding upon receiving the report from the UE.

Alternatively, the UE may transmit the report using a fixed payload size and a variable quantization granularity. In some aspects, despite a total quantity of reference signal resources IDs the UE may include in the report, the UE may use a same total quantity of bits in each payload 405. That is, the payload size of each payload 405 of the report may remain the same independent of a quantity of the reference signal resource IDs included in the second set. In addition, a quantization granularity may vary depending on the total quantity of bits in each payload 405 and the quantity of reference signal resource IDs included in the report. For example, the total quantity of bits used to indicate each quantized RSRP measurement value or each quantized SINR measurement value in a payload 405 may vary.

The UE may determine a quantization granularity for including the measurements in the report based on a quantity of bits allocated to each payload 405 and the quantity of reference signal resource IDs in the second set. Alternatively, the network entity may configure multiple quantization granularity options, each option associated with the total quantity of bits allocated to each payload 405 to transmit the report and the total quantity of reference signal resource IDs in the second set. The UE may receive an indication of the one or more options (e.g., one or more of the quantity of bits or an association between the quantity of bits and the quantization granularity) from the network entity and determine the quantization granularity for each of the payloads 405 based on the indication. As such, which quantization granularity is used for indicating measurement values corresponding to particular reference signal resource IDs may be based on a configuration or indication from the network entity, or may be based on a determination by the UE. In addition, the network entity may configure or dynamically change the total quantity of bits for transmitting the report in the payloads 405.

In some aspects, the UE may transmit the report in the first portion 420-a and the second portion 420-b as described herein using the fixed payload size and the variable quantization granularity. For example, the UE may transmit the indication of the second set 425 in the first portion 420-a and transmit the payloads 405 (e.g., the measurements) in the second portion 420-b, where the payloads 405 may each have the same size (e.g., same quantity of bits) and variable quantization granularities.

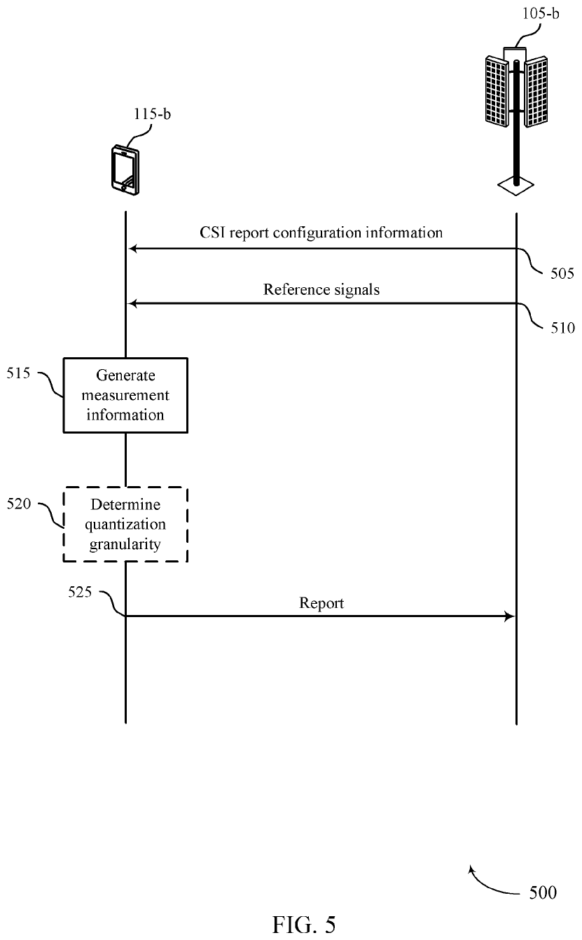

FIG. 5 illustrates an example of a process flow 500 that supports RSRP fingerprint reporting for beam blockage prediction in accordance with one or more aspects of the present disclosure. The process flow 500 may implement aspects of wireless communications systems 100 and 200, or may be implemented by aspects of the wireless communications system 100 and 200. For example, the process flow 500 may illustrate operations between a UE 115-b (e.g., a first network node) and a network entity 105-b (e.g., a second network node), which may be examples of corresponding devices described herein. In the following description of the process flow 500, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 500, and other operations may be added to the process flow 500.

At 505, the UE 115-b may receive, from the network entity 105-b, CSI report configuration information including a first set of one or more reference signal resource IDs, where each respective reference signal resource ID of the first set of one or more reference signal resource IDs corresponds to a respective reference signal resource for which respective measurement information is a candidate for inclusion in or is to be included in a report (e.g., a CSI report) for transmission to the second network node. In some aspects, the reference signal resources may correspond to CSI-RS resources (e.g., CSI-RS beams), SSB resources (e.g., SSB beams), or other reference signal resources. In some cases, the CSI report configuration information may refer to or include a CSI report setting.

At 510, the UE 115-b may receive, from the network entity 105-b, one or more reference signals using multiple reference signal resources that correspond to the respective reference signal resource IDs of the first set of one or more reference signal resource IDs. That is, the UE 115-b may receive one or more reference signals (e.g., CSI-RSs, SSBs) via one or more corresponding beams (e.g., CSI-RS beams, SSB beams).

At 515, the UE 115-b may generate respective measurement information for each respective reference signal resource of the multiple reference signal resources. For example, the UE 115-b may generate the respective measurement information based on measuring an RSRP, an SINR, or other channel characteristic for each reference signal resource. In some aspects, the respective measurement information may be included in an information element for inclusion in the report.

At 520, the UE 115-b may determine a quantization granularity for inclusion of the respective measurement information in the report based on a quantity of bits used for a payload of the report and the quantity of reference signal resource IDs for which respective measurement information is to be included in the report. For example, the UE 115-b may utilize a fixed quantization granularity and a variable payload size, or a variable quantization granularity and a fixed payload size to transmit the report to the network entity 105-b, the report including the respective measurement information.

At 525, the UE 115-b may transmit the report to the network entity 105-b, where the report includes, based on the CSI report configuration information, the respective measurement information corresponding to each respective reference signal resource of the multiple reference signal resources that corresponds to each respective reference signal resource ID of a second set of one or more reference signal resource IDs, where the second set of one or more reference signal resource IDs is the first set of one or more reference signal resource IDs or is a subset of the first set of one or more reference signal resource IDs. That is, the second set may be the first set in cases where the network entity 105-b configures or dynamically indicates the second set, and the second set may be a subset of the first set in cases where the UE 115-b determines the second set. As such, the UE 115-b may report the respective measurement values to indicate an RSRP fingerprint of the environment of the UE 115-b and the network entity 105-b, which the network entity 105-b may use to predict beam blockages.

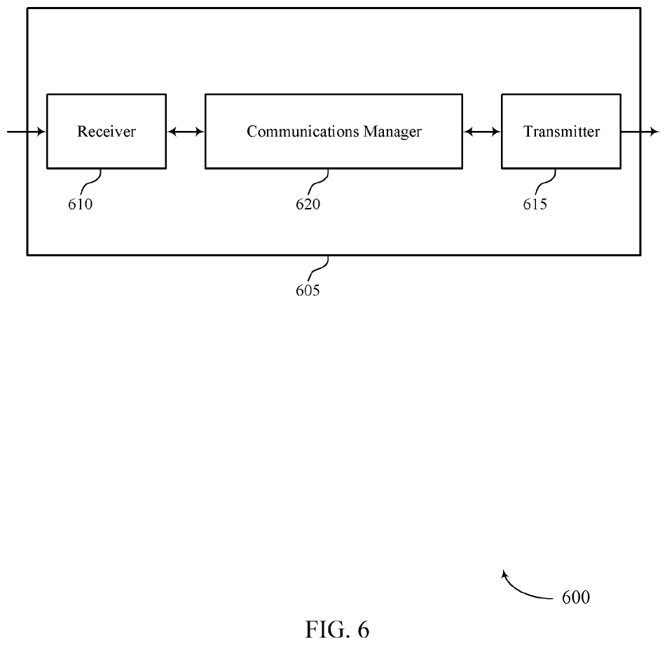

FIG. 6 shows a block diagram 600 of a device 605 that supports RSRP fingerprint reporting for beam blockage prediction in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to RSRP fingerprint reporting for beam blockage prediction). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to RSRP fingerprint reporting for beam blockage prediction). In some aspects, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of RSRP fingerprint reporting for beam blockage prediction as described herein. For example, the communications manager 620, the receiver 610, the transmitter 615, or various combinations or components thereof may support a method for performing one or more of the functions described herein.

In some aspects, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a first network node in accordance with examples as disclosed herein. For example, the communications manager 620 may be configured as or otherwise support a means for receiving, from a second network node, CSI report configuration information including a first set of one or more reference signal resource IDs, where each respective reference signal resource ID of the first set of one or more reference signal resource IDs corresponds to a respective reference signal resource for which respective measurement information is a candidate for inclusion in or is to be included in a report for transmission to the second network node. The communications manager 620 may be configured as or otherwise support a means for generating respective measurement information for each respective reference signal resource of a set of multiple reference signal resources. The communications manager 620 may be configured as or otherwise support a means for transmitting, to the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDs is the first set of one or more reference signal resource IDs or is a subset of the first set of one or more reference signal resource IDs.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for RSRP fingerprint reporting, which may reduce signaling overhead, thus, decreasing power consumption at a network node. In addition, the described techniques may enable a network node to more accurately predict beam blockages, which may reduce the chance of dropped or failed transmissions between network nodes.

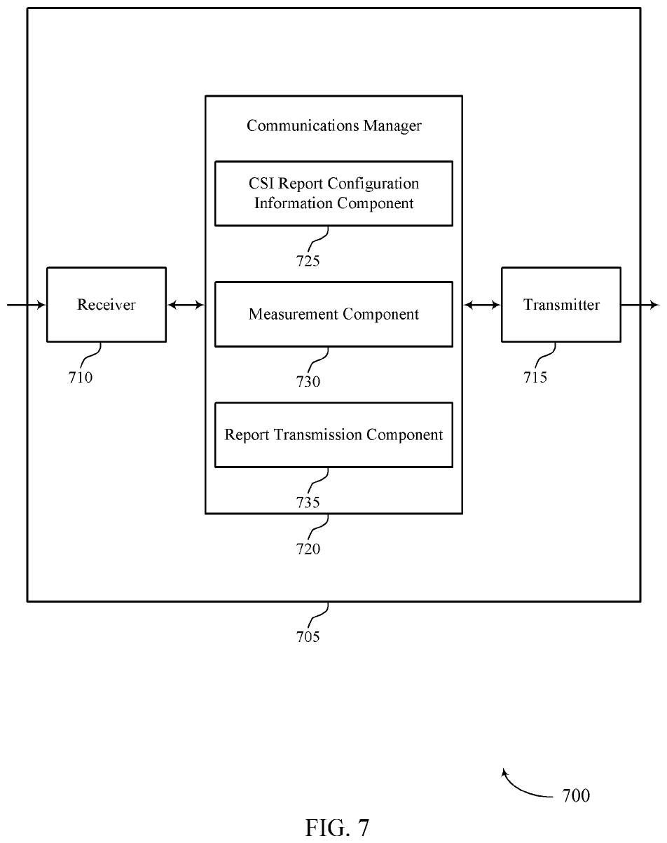

FIG. 7 shows a block diagram 700 of a device 705 that supports RSRP fingerprint reporting for beam blockage prediction in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to RSRP fingerprint reporting for beam blockage prediction). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to RSRP fingerprint reporting for beam blockage prediction). In some aspects, the transmitter 715 may be co-located with a receiver 710 in a transceiver module. The transmitter 715 may utilize a single antenna or a set of multiple antennas.

The device 705, or various components thereof, may be an example of means for performing various aspects of RSRP fingerprint reporting for beam blockage prediction as described herein. For example, the communications manager 720 may include a CSI report configuration information component 725, a measurement component 730, a report transmission component 735, or any combination thereof. The communications manager 720 may be an example of aspects of a communications manager 620 as described herein. In some aspects, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first network node in accordance with examples as disclosed herein. The CSI report configuration information component 725 may be configured as or otherwise support a means for receiving, from a second network node, CSI report configuration information including a first set of one or more reference signal resource IDs, where each respective reference signal resource ID of the first set of one or more reference signal resource IDs corresponds to a respective reference signal resource for which respective measurement information is a candidate for inclusion in or is to be included in a report for transmission to the second network node. The measurement component 730 may be configured as or otherwise support a means for generating respective measurement information for each respective reference signal resource of a set of multiple reference signal resources. The report transmission component 735 may be configured as or otherwise support a means for transmitting, to the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDs is the first set of one or more reference signal resource IDs or is a subset of the first set of one or more reference signal resource IDs.

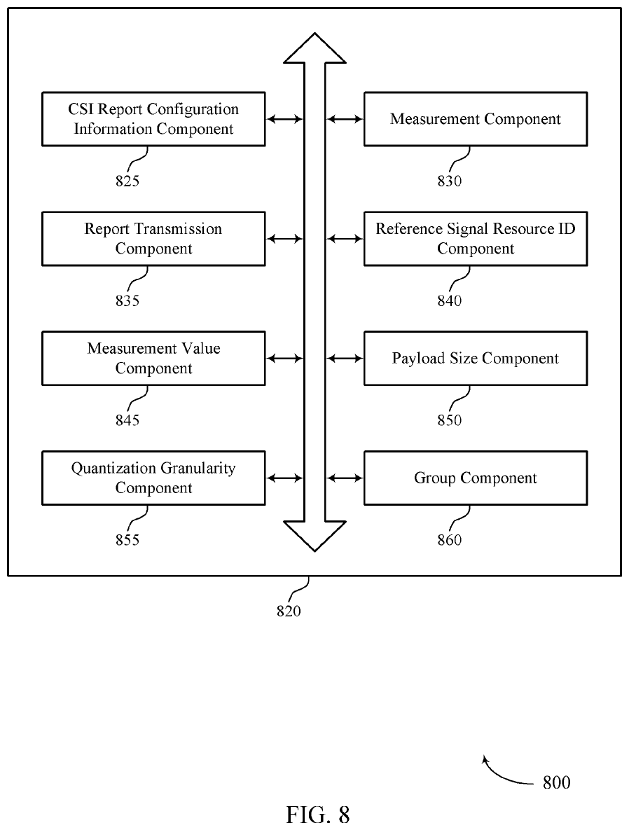

FIG. 8 shows a block diagram 800 of a communications manager 820 that supports RSRP fingerprint reporting for beam blockage prediction in accordance with one or more aspects of the present disclosure. The communications manager 820 may be an example of aspects of a communications manager 620, a communications manager 720, or both, as described herein. The communications manager 820, or various components thereof, may be an example of means for performing various aspects of RSRP fingerprint reporting for beam blockage prediction as described herein. For example, the communications manager 820 may include a CSI report configuration information component 825, a measurement component 830, a report transmission component 835, a reference signal resource ID component 840, a measurement value component 845, a payload size component 850, a quantization granularity component 855, a group component 860, or any combination thereof. Each of these components may communicate, directly or indirectly, with one another (e.g., via one or more buses).

The communications manager 820 may support wireless communication at a first network node in accordance with examples as disclosed herein. The CSI report configuration information component 825 may be configured as or otherwise support a means for receiving, from a second network node, CSI report configuration information including a first set of one or more reference signal resource IDs, where each respective reference signal resource ID of the first set of one or more reference signal resource IDs corresponds to a respective reference signal resource for which respective measurement information is a candidate for inclusion in or is to be included in a report for transmission to the second network node. The measurement component 830 may be configured as or otherwise support a means for generating respective measurement information for each respective reference signal resource of a set of multiple reference signal resources. The report transmission component 835 may be configured as or otherwise support a means for transmitting, to the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDs is the first set of one or more reference signal resource IDs or is a subset of the first set of one or more reference signal resource IDs.

In some aspects, the second set of one or more reference signal resource IDs is the subset of the first set of one or more reference signal resource IDs, where the first set of one or more reference signal resource IDs includes a first quantity of reference signal resource IDs and the second set of one or more reference signal resource IDs includes a second quantity of reference signal resource IDs, and where the first quantity is greater than the second quantity.

In some aspects, the first network node receives the CSI report configuration information in RRC signaling, a MAC-CE, or DCI. In some aspects, the CSI report configuration information includes a CSI resource setting associated with a CSI report setting and a CSI resource set, where the CSI resource setting includes the first set of one or more reference signal resource IDs.

In some aspects, the report transmission component 835 may be configured as or otherwise support a means for transmitting a set of multiple reports based on the CSI report configuration information, where the set of multiple reports includes the first report, and where the second set of one or more reference signal resource IDs is different for each respective report of the set of multiple reports.

In some aspects, the CSI report configuration information component 825 may be configured as or otherwise support a means for receiving, from the second network node, second CSI report configuration information indicative of the second set of one or more reference signal resource IDs from the first set of one or more reference signal resource IDs.

In some aspects, to support receiving the second CSI report configuration information, the CSI report configuration information component 825 may be configured as or otherwise support a means for receiving the second CSI report configuration information in a MAC-CE or DCI.

In some aspects, the second set of one or more reference signal resource IDs is the subset of the first set of one or more reference signal resource IDs, where the first set of one or more reference signal resource IDs includes a set of multiple subsets of one or more reference signal resource IDs, and where the subset of the first set of one or more reference signal resource IDs is a first subset of the set of multiple subsets.

In some aspects, the first subset is based on a standard deviation of respective measurement information for each reference signal resource corresponding to each reference signal resource ID from the first subset. In some aspects, the first subset is based on a RSRP change rate, a SINR change rate, or any combination thereof. In some aspects, the report only includes measurement information for each respective reference signal resource of the set of multiple reference signal resources that corresponds to each respective reference signal resource ID of the first subset.

In some aspects, the respective measurement information included in the report includes a first measurement value corresponding to a first reference signal resource of the set of multiple reference signal resources that corresponds to a first reference signal resource ID of the second set of one or more reference signal resource IDs, and one or more respective measurement values corresponding to other reference signal resources of the set of multiple reference signal resources that corresponds to other reference signal resource IDs of the second set of one or more reference signal resource IDs, and where the one or more respective measurement values are included in the report in an order relative to the first reference signal resource ID.

In some aspects, the first measurement value corresponds to a highest RSRP or SINR measurement. In some aspects, the order is in either an ascending reference signal resource ID order relative to the first reference signal resource ID or a descending reference signal resource ID order relative to the first reference signal resource ID.

In some aspects, the report includes, independent of a quantity of reference signal resource IDs in the second set of one or more reference signal resource IDs, a quantity of bits to represent the respective measurement information for the reference signal resources that correspond to each reference signal resource in the second set of one or more reference signal resource IDs. In some aspects, a payload size of the report is based on the quantity of the reference signal resource IDs in the second set of one or more reference signal resource IDs.

In some aspects, to support transmitting the report, the report transmission component 835 may be configured as or otherwise support a means for transmitting the report using one or more control channel resources or an MCS. In some aspects, the report includes a first portion and a second portion, where the first portion includes an indication of the second set of one or more reference signal resource IDs and the second portion includes the respective measurement information, and where the first portion is fixed in size and the second portion is variable in size. In some aspects, a quantity of bits used for a payload of the report is fixed independent of a quantity of the reference signal resource IDs of the second set of one or more reference signal resource IDs.

In some aspects, the quantization granularity component 855 may be configured as or otherwise support a means for determining a quantization granularity for inclusion of the respective measurement information in the report based on the quantity of bits and the quantity of the reference signal resource IDs of the second set of one or more reference signal resource IDs.

In some aspects, to support, determining the quantization granularity, the quantization granularity component 855 may be configured as or otherwise support a means for receiving an indication of one or more of the quantity of bits or an association between the quantity of bits and the quantization granularity.

In some aspects, the respective measurement information included in the report is organized in a set of multiple groups, each group including a respective first reference signal resource ID of the second set of one or more reference signal resource IDs and the respective measurement information corresponding to other reference signal resource IDs of the second set of one or more reference signal resource IDs, the respective measurement information being included in the report in the set of multiple groups either in an ascending reference signal resource ID order relative to the respective first reference signal resource ID or a descending reference signal resource ID order relative to the respective first reference signal resource ID.

In some aspects, the groups corresponding to the second set of one or more reference signal resource IDs are based on the CSI report configuration information or an angular separation between the reference signal resources corresponding to the reference signal resource IDs in the second set of one or more reference signal resource IDs.

In some aspects, the report includes a set of multiple groups, where each respective group includes a respective subset of the second set of one or more reference signal resource IDs including a respective first reference signal resource ID and a respective second reference signal ID, where the respective measurement information corresponding to each respective first reference signal resource ID in each respective group is represented by a first quantity of bits, and where the respective measurement information corresponding to each respective second reference signal resource ID in each respective group is represented by a second quantity of bits different from the first quantity of bits.

In some aspects, each respective group is included in the report either in an ascending reference signal resource ID order relative to the respective first reference signal resource ID or a descending reference signal resource ID order relative to the respective first reference signal resource ID. In some aspects, each respective reference signal resource of the one or more reference signal resources is either a CSI-RS resource or an SSB resource.

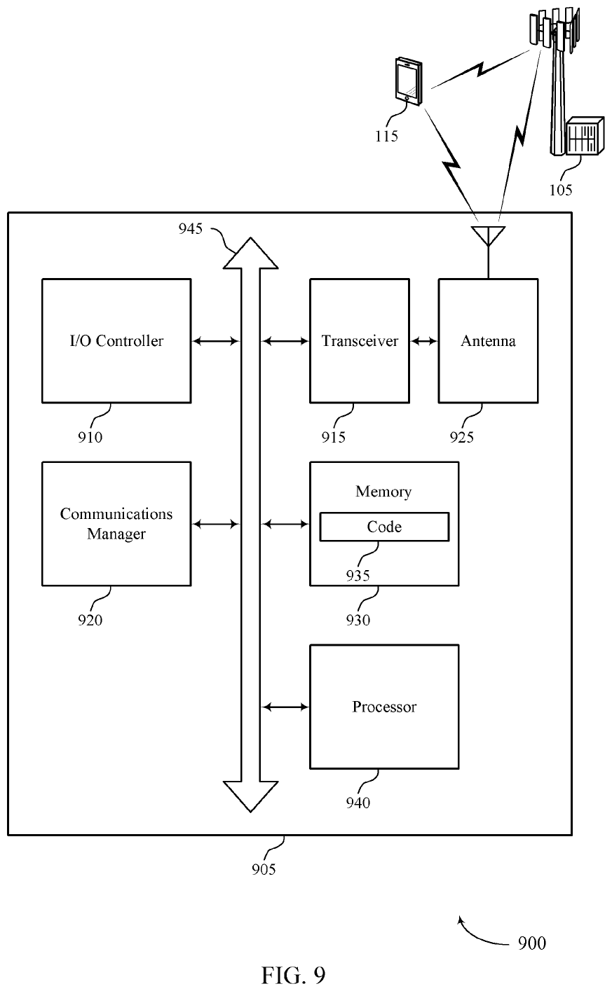

FIG. 9 shows a diagram of a system 900 including a device 905 that supports RSRP fingerprint reporting for beam blockage prediction in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting RSRP fingerprint reporting for beam blockage prediction). For example, the device 905 or a component of the device 905 may include a processor 940 and memory 930 coupled with or to the processor 940, the processor 940 and memory 930 configured to perform various functions described herein.

The communications manager 920 may support wireless communication at a first network node in accordance with examples as disclosed herein. For example, the communications manager 920 may be configured as or otherwise support a means for receiving, from a second network node, CSI report configuration information including a first set of one or more reference signal resource IDs, where each respective reference signal resource ID of the first set of one or more reference signal resource IDs corresponds to a respective reference signal resource for which respective measurement information is a candidate for inclusion in or is to be included in a report for transmission to the second network node. The communications manager 920 may be configured as or otherwise support a means for generating respective measurement information for each respective reference signal resource of a set of multiple reference signal resources. The communications manager 920 may be configured as or otherwise support a means for transmitting, to the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDs is the first set of one or more reference signal resource IDs or is a subset of the first set of one or more reference signal resource IDs.

By including or configuring the communications manager 920 in accordance with examples as described herein, the device 905 may support techniques for RSRP fingerprint reporting, which may reduce signaling overhead, thus, decreasing power consumption at a network node. In addition, the described techniques may enable a network node to more accurately predict beam blockages, which may reduce the chance of dropped or failed transmissions between network nodes.

In some aspects, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some aspects, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of RSRP fingerprint reporting for beam blockage prediction as described herein, or the processor 940 and the memory 930 may be otherwise configured to perform or support such operations.

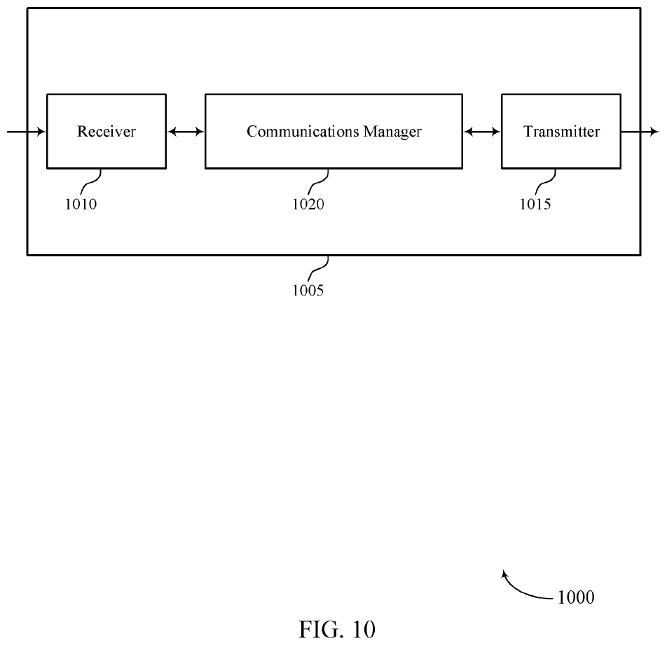

FIG. 10 shows a block diagram 1000 of a device 1005 that supports RSRP fingerprint reporting for beam blockage prediction in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some aspects, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some aspects, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of RSRP fingerprint reporting for beam blockage prediction as described herein. For example, the communications manager 1020, the receiver 1010, the transmitter 1015, or various combinations or components thereof may support a method for performing one or more of the functions described herein.

In some aspects, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a first network node in accordance with examples as disclosed herein. For example, the communications manager 1020 may be configured as or otherwise support a means for transmitting, to a second network node, CSI report configuration information including a first set of one or more reference signal resource IDs, where each respective reference signal resource ID of the one or more reference signal resource IDs corresponds to a respective reference signal resource for which respective measurement information is a candidate for inclusion in or is to be included in a report for transmission to the second network node. The communications manager 1020 may be configured as or otherwise support a means for transmitting a set of multiple reference signals using the reference signal resources that correspond to the respective reference signal resource IDs of the first set of one or more reference signal resource IDs. The communications manager 1020 may be configured as or otherwise support a means for receiving, from the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDS is the first set of one or more reference signal resource IDs or is a subset of the first set of one or more reference signal resource IDs.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for RSRP fingerprint reporting, which may reduce signaling overhead, thus, decreasing power consumption at a network node. In addition, the described techniques may enable a network node to more accurately predict beam blockages, which may reduce the chance of dropped or failed transmissions between network nodes.

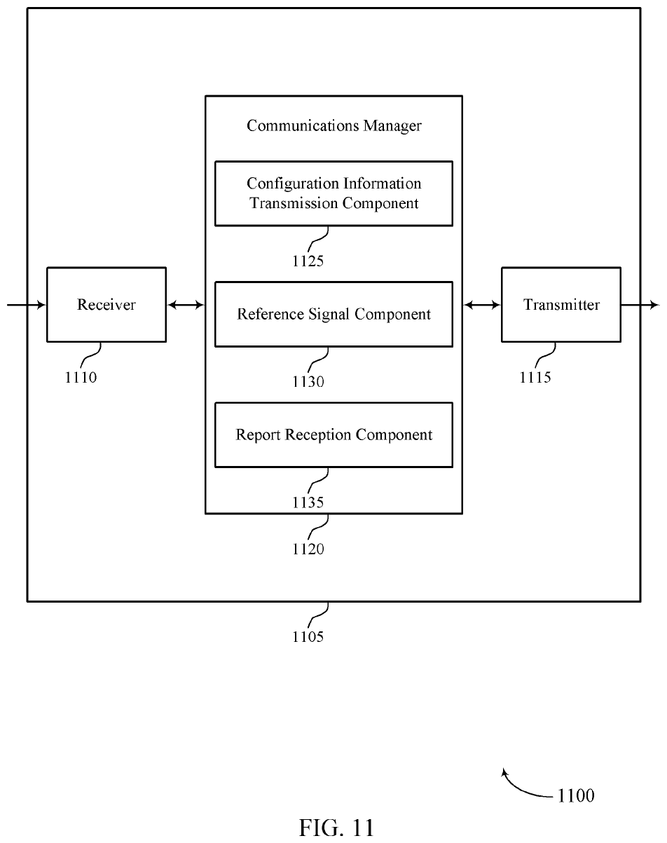

FIG. 11 shows a block diagram 1100 of a device 1105 that supports RSRP fingerprint reporting for beam blockage prediction in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some aspects, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some aspects, the transmitter 1115 and the receiver 1110 may be co-located in a transceiver, which may include or be coupled with a modem.

The device 1105, or various components thereof, may be an example of means for performing various aspects of RSRP fingerprint reporting for beam blockage prediction as described herein. For example, the communications manager 1120 may include a configuration information transmission component 1125, a reference signal component 1130, a report reception component 1135, or any combination thereof. The communications manager 1120 may be an example of aspects of a communications manager 1020 as described herein. In some aspects, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a first network node in accordance with examples as disclosed herein. The configuration information transmission component 1125 may be configured as or otherwise support a means for transmitting, to a second network node, CSI report configuration information including a first set of one or more reference signal resource IDs, where each respective reference signal resource ID of the one or more reference signal resource IDs corresponds to a respective reference signal resource for which respective measurement information is a candidate for inclusion in or is to be included in a report for transmission to the second network node. The reference signal component 1130 may be configured as or otherwise support a means for transmitting a set of multiple reference signals using the reference signal resources that correspond to the respective reference signal resource IDs of the first set of one or more reference signal resource IDs. The report reception component 1135 may be configured as or otherwise support a means for receiving, from the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDS is the first set of one or more reference signal resource IDs or is a subset of the first set of one or more reference signal resource IDs.

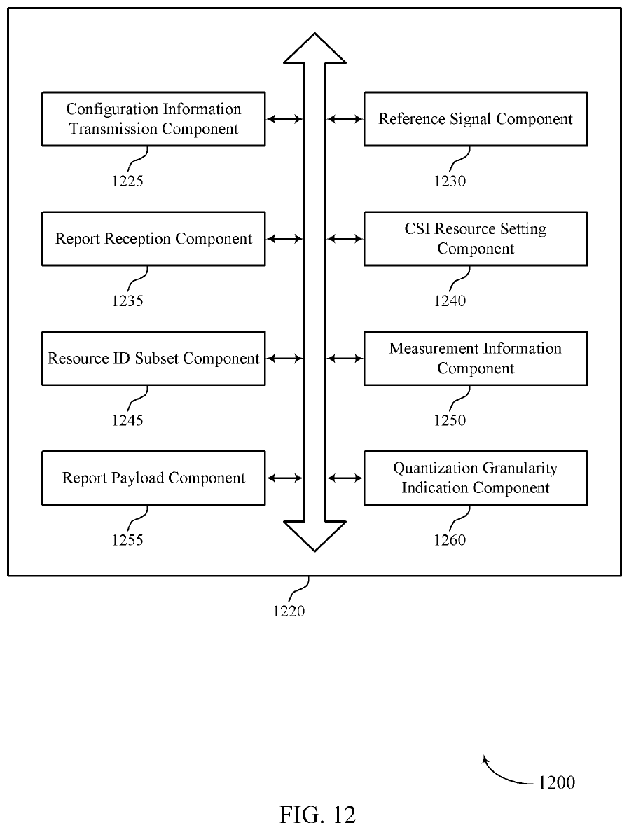

FIG. 12 shows a block diagram 1200 of a communications manager 1220 that supports RSRP fingerprint reporting for beam blockage prediction in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of RSRP fingerprint reporting for beam blockage prediction as described herein. For example, the communications manager 1220 may include a configuration information transmission component 1225, a reference signal component 1230, a report reception component 1235, a CSI resource setting component 1240, a resource ID subset component 1245, a measurement information component 1250, a report payload component 1255, a quantization granularity indication component 1260, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a first network node in accordance with examples as disclosed herein. The configuration information transmission component 1225 may be configured as or otherwise support a means for transmitting, to a second network node, CSI report configuration information including a first set of one or more reference signal resource IDs, where each respective reference signal resource ID of the one or more reference signal resource IDs corresponds to a respective reference signal resource for which respective measurement information is a candidate for inclusion in or is to be included in a report for transmission to the second network node. The reference signal component 1230 may be configured as or otherwise support a means for transmitting a set of multiple reference signals using the reference signal resources that correspond to the respective reference signal resource IDs of the first set of one or more reference signal resource IDs. The report reception component 1235 may be configured as or otherwise support a means for receiving, from the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDS is the first set of one or more reference signal resource IDs or is a subset of the first set of one or more reference signal resource IDs.

In some aspects, the second set of one or more reference signal resource IDs is the subset of the first set of one or more reference signal resource IDs, where the first set of one or more reference signal resource IDs includes a first quantity of reference signal resource IDs and the second set of one or more reference signal resource IDs includes a second quantity of reference signal resource IDs, and where the first quantity is greater than the second quantity.

In some aspects, to support transmitting the CSI report configuration information, the configuration information transmission component 1225 may be configured as or otherwise support a means for transmitting the CSI report configuration information in RRC signaling, a MAC-CE, or DCI.

In some aspects, the report reception component 1235 may be configured as or otherwise support a means for receiving a set of multiple reports based on the CSI report configuration information, where the set of multiple reports includes the first report, and where the second set of one or more reference signal resource IDs is different for each respective report of the set of multiple reports.

In some aspects, the CSI report configuration information includes a CSI resource setting associated with a CSI report setting and a CSI resource set, where the CSI resource setting includes the first set of one or more reference signal resource IDs. In some aspects, the configuration information transmission component 1225 may be configured as or otherwise support a means for transmitting, to the second network node, second CSI report configuration information indicative of the second set of one or more reference signal resource IDS from the first set of one or more reference signal resource IDs.

In some aspects, to support transmitting the second CSI report configuration information, the configuration information transmission component 1225 may be configured as or otherwise support a means for transmitting the second CSI report configuration information in a MAC-CE or DCI.

In some aspects, the second set of one or more reference signal resource IDs is the subset of the first set of one or more reference signal resource IDs, where the first set of one or more reference signal resource IDs includes a set of multiple subsets of one or more reference signal resource IDs, and where the subset of the first set of one or more reference signal resource IDs is a first subset of the set of multiple subsets.

In some aspects, the report includes an indication of the first subset. In some aspects, the first subset of one or more reference signal resource IDs is based on a standard deviation of respective measurement information for each reference signal resource corresponding to each reference signal resource ID from the first subset. In some aspects, the first subset is based on a RSRP change rate, a SINR change rate, or any combination thereof. In some aspects, the report only includes measurement information for each respective reference signal resource of the set of multiple reference signal resources that corresponds to each respective reference signal resource ID of the first subset.

In some aspects, the respective measurement information included in the report includes a first measurement value corresponding to a first reference signal resource of the set of multiple reference signal resources that corresponds to a first reference signal resource ID of the second set of one or more reference signal resource IDs, and one or more respective measurement values corresponding to other reference signal resources of the set of multiple reference signal resources that corresponds to a first reference signal resource ID of the second set of one or more reference signal resource IDs, and where the one or more respective measurement values are included in the report in an order relative to the first reference signal resource ID.

In some aspects, the first measurement value corresponds to a highest RSRP or SINR measurement. In some aspects, the order is in either an ascending reference signal resource ID order relative to the first reference signal resource ID or a descending reference signal resource ID order relative to the first reference signal resource ID.

In some aspects, the report includes, independent of a quantity of reference signal resource IDs in the second set of one or more reference signal resource IDs, a quantity of bits that represents the respective measurement information for the reference signal resources that correspond to each reference signal resource in the second set of one or more reference signal resource IDs. In some aspects, a payload size of the report is based on the quantity of the reference signal resource IDs in the second set of one or more reference signal resource IDs.

In some aspects, to support receiving the report, the report payload component 1255 may be configured as or otherwise support a means for receiving the report using one or more control channel resources or an MCS.

In some aspects, the report includes a first portion and a second portion of the report, where the first portion includes an indication of the second set of one or more reference signal resource IDs and the second portion includes the respective measurement information, and where the first portion is fixed in size and the second portion is variable in size. In some aspects, a quantity of bits used for a payload of the report is fixed independent of a quantity of the reference signal resource IDS of the second set of one or more reference signal resource IDs.

In some aspects, the quantization granularity indication component 1260 may be configured as or otherwise support a means for transmitting an indication of one or more of the quantity of bits or an association between the quantity of bits and a quantization granularity.

In some aspects, the respective measurement information included in the report is organized in a set of multiple groups, each group including a respective first reference signal resource ID of the second set of one or more reference signal resource IDs and the respective measurement information corresponding to other reference signal resource IDs of the second set of one or more reference signal resource IDs, the respective measurement information being included in the report in the set of multiple groups either in an ascending reference signal resource ID order relative to the respective first reference signal resource ID or a descending reference signal resource ID order relative to the respective first reference signal resource ID.

In some aspects, the groups corresponding to the second set of one or more reference signal resource IDs are based on the CSI report configuration information or an angular separation between the reference signal resources corresponding to the reference signal resource IDs in the second set of one or more reference signal resource IDs.

In some aspects, the report includes a set of multiple groups, where each respective group includes a respective subset of the second set of one or more reference signal resource IDs including a respective first reference signal resource ID and a respective second reference signal ID, where the respective measurement information corresponding to each respective first reference signal resource ID in each respective group is represented by a first quantity of bits, and where the respective measurement information corresponding to each respective second reference signal resource ID in each respective group is represented by a second quantity of bits different from the first quantity of bits.

In some aspects, each respective group is included in the report either in an ascending reference signal resource ID order relative to the respective first reference signal resource ID or a descending reference signal resource ID order relative to the respective first reference signal resource ID. In some aspects, each respective reference signal resource of the one or more reference signal resources is either a CSI-RS resource or an SBB resource.

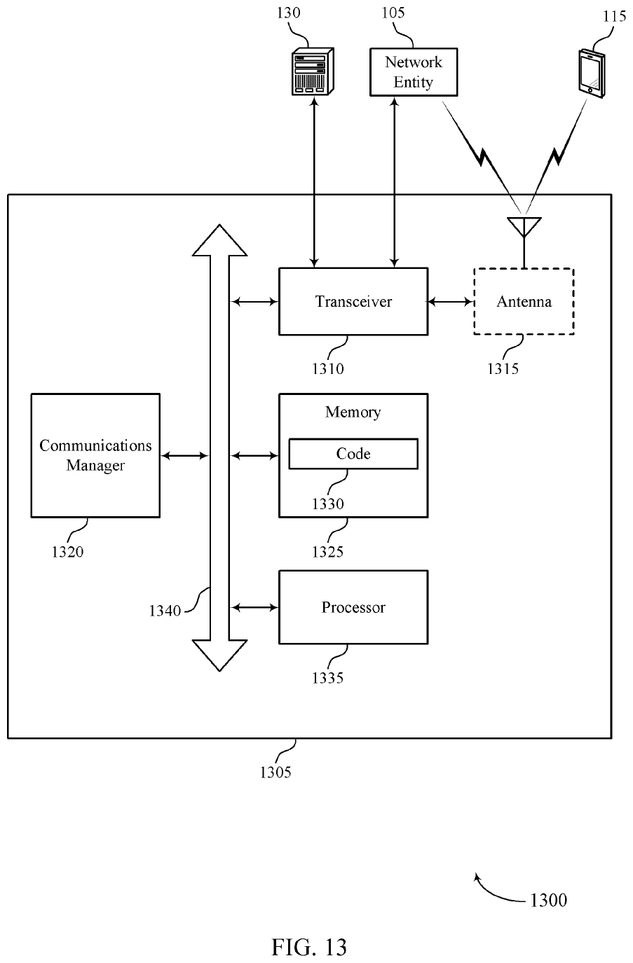

FIG. 13 shows a diagram of a system 1300 including a device 1305 that supports RSRP fingerprint reporting for beam blockage prediction in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some aspects, the transceiver 1310 may include a wired transceiver and may communicate bi-directionally with another wired transceiver. Additionally, or alternatively, in some aspects, the transceiver 1310 may include a wireless transceiver and may communicate bi-directionally with another wireless transceiver. In some aspects, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some aspects, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting RSRP fingerprint reporting for beam blockage prediction). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some aspects, a bus 1340 may support communications of (e.g., within) a protocol layer of a protocol stack. In some aspects, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some aspects, the communications manager 1320 may manage aspects of communications with a core network 130 (e.g., via one or more wired or wireless backhaul links). For example, the communications manager 1320 may manage the transfer of data communications for client devices, such as one or more UEs 115. In some aspects, the communications manager 1320 may manage communications with other network entities 105, and may include a controller or scheduler for controlling communications with UEs 115 in cooperation with other network entities 105. In some aspects, the communications manager 1320 may support an X2 interface within an LTE/LTE-A wireless communications network technology to provide communication between network entities 105.

The communications manager 1320 may support wireless communication at a first network node in accordance with examples as disclosed herein. For example, the communications manager 1320 may be configured as or otherwise support a means for transmitting, to a second network node, CSI report configuration information including a first set of one or more reference signal resource IDs, where each respective reference signal resource ID of the one or more reference signal resource IDs corresponds to a respective reference signal resource for which respective measurement information is a candidate for inclusion in or is to be included in a report for transmission to the second network node. The communications manager 1320 may be configured as or otherwise support a means for transmitting a set of multiple reference signals using the reference signal resources that correspond to the respective reference signal resource IDs of the first set of one or more reference signal resource IDs. The communications manager 1320 may be configured as or otherwise support a means for receiving, from the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDS is the first set of one or more reference signal resource IDs or is a subset of the first set of one or more reference signal resource IDs.

By including or configuring the communications manager 1320 in accordance with examples as described herein, the device 1305 may support techniques for RSRP fingerprint reporting, which may reduce signaling overhead, thus, decreasing power consumption at a network node. In addition, the described techniques may enable a network node to more accurately predict beam blockages, which may reduce the chance of dropped or failed transmissions between network nodes.

In some aspects, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some aspects, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of RSRP fingerprint reporting for beam blockage prediction as described herein, or the processor 1335 and the memory 1325 may be otherwise configured to perform or support such operations.

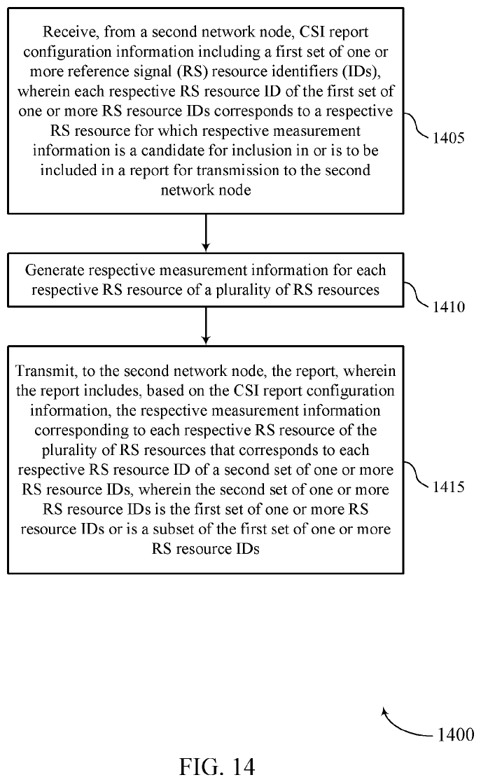

FIG. 14 shows a flowchart illustrating a method 1400 that supports RSRP fingerprint reporting for beam blockage prediction in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some aspects, a UE may execute a set of instructions to control the functional elements of the UE to perform the described functions. Additionally, or alternatively, the UE may perform aspects of the described functions using special-purpose hardware.

At 1405, the method may include receiving, from a second network node, CSI report configuration information including a first set of one or more reference signal resource IDs, where each respective reference signal resource ID of the first set of one or more reference signal resource IDs corresponds to a respective reference signal resource for which respective measurement information is a candidate for inclusion in or is to be included in a report for transmission to the second network node. The operations of 1405 may be performed in accordance with examples as disclosed herein. In some aspects, aspects of the operations of 1405 may be performed by a CSI report configuration information component 825 as described with reference to FIG. 8.

At 1410, the method may include generating respective measurement information for each respective reference signal resource of a set of multiple reference signal resources. The operations of 1410 may be performed in accordance with examples as disclosed herein. In some aspects, aspects of the operations of 1410 may be performed by a measurement component 830 as described with reference to FIG. 8.

At 1415, the method may include transmitting, to the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDs is the first set of one or more reference signal resource IDs or is a subset of the first set of one or more reference signal resource IDs. The operations of 1415 may be performed in accordance with examples as disclosed herein. In some aspects, aspects of the operations of 1415 may be performed by a report transmission component 835 as described with reference to FIG. 8.

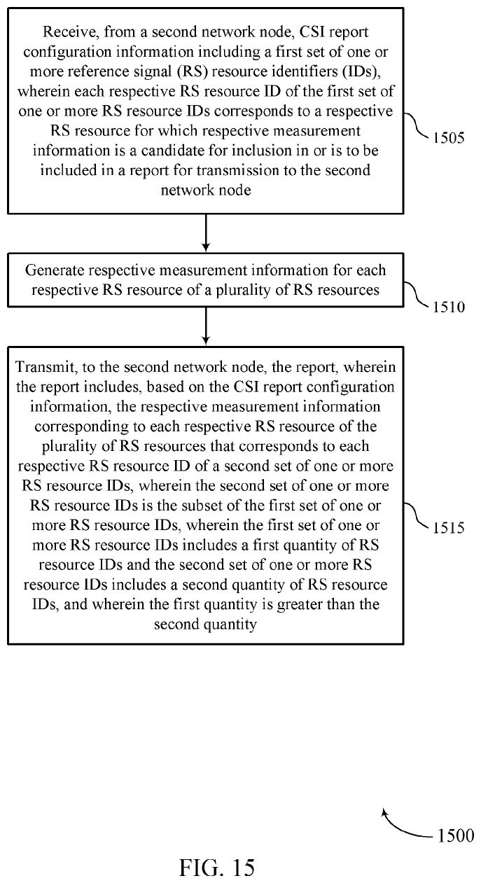

FIG. 15 shows a flowchart illustrating a method 1500 that supports RSRP fingerprint reporting for beam blockage prediction in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some aspects, a UE may execute a set of instructions to control the functional elements of the UE to perform the described functions. Additionally, or alternatively, the UE may perform aspects of the described functions using special-purpose hardware.

At 1505, the method may include receiving, from a second network node, CSI report configuration information including a first set of one or more reference signal resource IDs, where each respective reference signal resource ID of the first set of one or more reference signal resource IDs corresponds to a respective reference signal resource for which respective measurement information is a candidate for inclusion in or is to be included in a report for transmission to the second network node. The operations of 1505 may be performed in accordance with examples as disclosed herein. In some aspects, aspects of the operations of 1505 may be performed by a CSI report configuration information component 825 as described with reference to FIG. 8.

At 1510, the method may include generating respective measurement information for each respective reference signal resource of a set of multiple reference signal resources. The operations of 1510 may be performed in accordance with examples as disclosed herein. In some aspects, aspects of the operations of 1510 may be performed by a measurement component 830 as described with reference to FIG. 8.

At 1515, the method may include transmitting, to the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDs is the subset of the first set of one or more reference signal resource IDs, where the first set of one or more reference signal resource IDs includes a first quantity of reference signal resource IDs and the second set of one or more reference signal resource IDs includes a second quantity of reference signal resource IDs, and where the first quantity is greater than the second quantity. The operations of 1515 may be performed in accordance with examples as disclosed herein. In some aspects, aspects of the operations of 1515 may be performed by a report transmission component 835 as described with reference to FIG. 8.

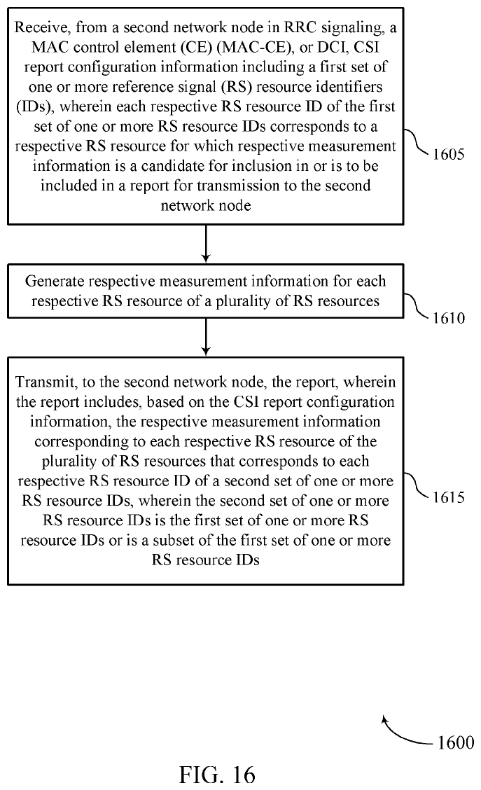

FIG. 16 shows a flowchart illustrating a method 1600 that supports RSRP fingerprint reporting for beam blockage prediction in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some aspects, a UE may execute a set of instructions to control the functional elements of the UE to perform the described functions. Additionally, or alternatively, the UE may perform aspects of the described functions using special-purpose hardware.

At 1605, the method may include receiving, from a second network node in RRC signaling, a MAC-CE, or DCI, CSI report configuration information including a first set of one or more reference signal resource IDs, where each respective reference signal resource ID of the first set of one or more reference signal resource IDs corresponds to a respective reference signal resource for which respective measurement information is a candidate for inclusion in or is to be included in a report for transmission to the second network node. The operations of 1605 may be performed in accordance with examples as disclosed herein. In some aspects, aspects of the operations of 1605 may be performed by a CSI report configuration information component 825 as described with reference to FIG. 8.

At 1610, the method may include generating respective measurement information for each respective reference signal resource of a set of multiple reference signal resources. The operations of 1610 may be performed in accordance with examples as disclosed herein. In some aspects, aspects of the operations of 1610 may be performed by a measurement component 830 as described with reference to FIG. 8.

At 1615, the method may include transmitting, to the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDs is the first set of one or more reference signal resource IDs or is a subset of the first set of one or more reference signal resource IDs. The operations of 1615 may be performed in accordance with examples as disclosed herein. In some aspects, aspects of the operations of 1615 may be performed by a report transmission component 835 as described with reference to FIG. 8.

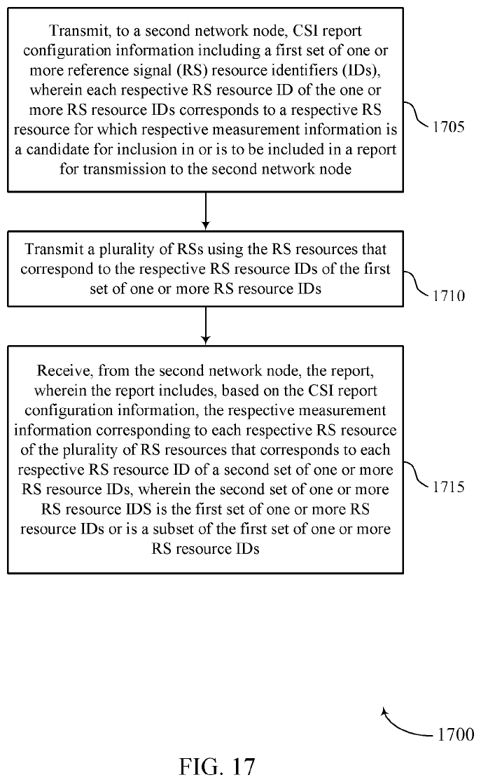

FIG. 17 shows a flowchart illustrating a method 1700 that supports RSRP fingerprint reporting for beam blockage prediction in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some aspects, a network entity may execute a set of instructions to control the functional elements of the network entity to perform the described functions. Additionally, or alternatively, the network entity may perform aspects of the described functions using special-purpose hardware.

At 1705, the method may include transmitting, to a second network node, CSI report configuration information including a first set of one or more reference signal resource IDs, where each respective reference signal resource ID of the one or more reference signal resource IDs corresponds to a respective reference signal resource for which respective measurement information is a candidate for inclusion in or is to be included in a report for transmission to the second network node. The operations of 1705 may be performed in accordance with examples as disclosed herein. In some aspects, aspects of the operations of 1705 may be performed by a configuration information transmission component 1225 as described with reference to FIG. 12.

At 1710, the method may include transmitting a set of multiple reference signals using the reference signal resources that correspond to the respective reference signal resource IDs of the first set of one or more reference signal resource IDs. The operations of 1710 may be performed in accordance with examples as disclosed herein. In some aspects, aspects of the operations of 1710 may be performed by a reference signal component 1230 as described with reference to FIG. 12.

At 1715, the method may include receiving, from the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDS is the first set of one or more reference signal resource IDs or is a subset of the first set of one or more reference signal resource IDs. The operations of 1715 may be performed in accordance with examples as disclosed herein. In some aspects, aspects of the operations of 1715 may be performed by a report reception component 1235 as described with reference to FIG. 12.

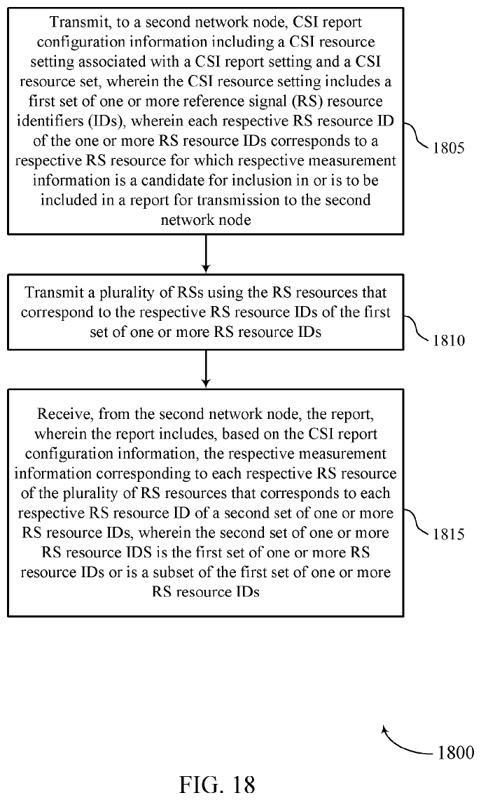

FIG. 18 shows a flowchart illustrating a method 1800 that supports RSRP fingerprint reporting for beam blockage prediction in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some aspects, a network entity may execute a set of instructions to control the functional elements of the network entity to perform the described functions. Additionally, or alternatively, the network entity may perform aspects of the described functions using special-purpose hardware.

At 1805, the method may include transmitting, to a second network node, CSI report configuration information including a CSI resource setting associated with a CSI report setting and a CSI resource set, where the CSI resource setting includes a first set of one or more reference signal resource IDs, where each respective reference signal resource ID of the one or more reference signal resource IDs corresponds to a respective reference signal resource for which respective measurement information is a candidate for inclusion in or is to be included in a report for transmission to the second network node. The operations of 1805 may be performed in accordance with examples as disclosed herein. In some aspects, aspects of the operations of 1805 may be performed by a configuration information transmission component 1225 as described with reference to FIG. 12.

At 1810, the method may include transmitting a set of multiple reference signals using the reference signal resources that correspond to the respective reference signal resource IDs of the first set of one or more reference signal resource IDs. The operations of 1810 may be performed in accordance with examples as disclosed herein. In some aspects, aspects of the operations of 1810 may be performed by a reference signal component 1230 as described with reference to FIG. 12.

At 1815, the method may include receiving, from the second network node, the report, where the report includes, based on the CSI report configuration information, the respective measurement information corresponding to each respective reference signal resource of the set of multiple reference signal resources that corresponds to each respective reference signal resource ID of a second set of one or more reference signal resource IDs, where the second set of one or more reference signal resource IDS is the first set of one or more reference signal resource IDs or is a subset of the first set of one or more reference signal resource IDs. The operations of 1815 may be performed in accordance with examples as disclosed herein. In some aspects, aspects of the operations of 1815 may be performed by a report reception component 1235 as described with reference to FIG. 12.

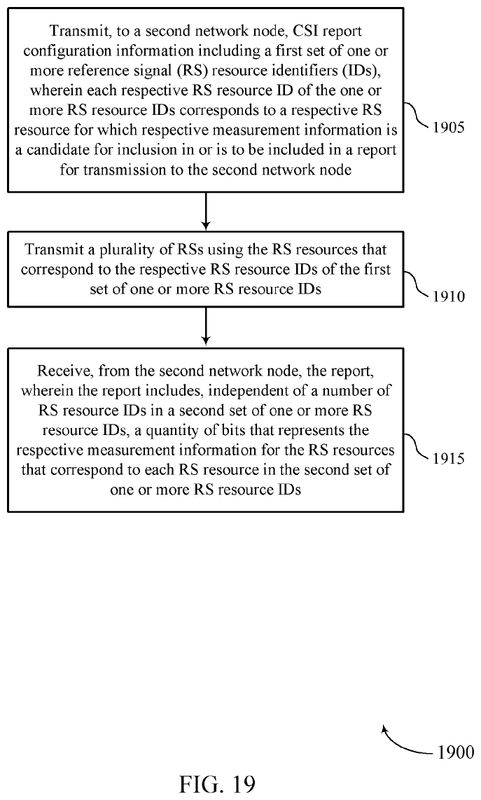

FIG. 19 shows a flowchart illustrating a method 1900 that supports RSRP fingerprint reporting for beam blockage prediction in accordance with one or more aspects of the present disclosure. The operations of the method 1900 may be implemented by a network entity or its components as described herein. For example, the operations of the method 1900 may be performed by a network entity as described with reference to FIGS. 1 through 5 and 10 through 13. In some aspects, a network entity may execute a set of instructions to control the functional elements of the network entity to perform the described functions. Additionally, or alternatively, the network entity may perform aspects of the described functions using special-purpose hardware.

At 1905, the method may include transmitting, to a second network node, CSI report configuration information including a first set of one or more reference signal resource IDs, where each respective reference signal resource ID of the one or more reference signal resource IDs corresponds to a respective reference signal resource for which respective measurement information is a candidate for inclusion in or is to be included in a report for transmission to the second network node. The operations of 1905 may be performed in accordance with examples as disclosed herein. In some aspects, aspects of the operations of 1905 may be performed by a configuration information transmission component 1225 as described with reference to FIG. 12.

At 1910, the method may include transmitting a set of multiple reference signals using the reference signal resources that correspond to the respective reference signal resource IDs of the first set of one or more reference signal resource IDs. The operations of 1910 may be performed in accordance with examples as disclosed herein. In some aspects, aspects of the operations of 1910 may be performed by a reference signal component 1230 as described with reference to FIG. 12.

At 1915, the method may include receiving, from the second network node, the report, where the report includes, independent of a quantity of reference signal resource IDs in a second set of one or more reference signal resource IDs, a quantity of bits that represents the respective measurement information for the reference signal resources that correspond to each reference signal resource in the second set of one or more reference signal resource IDs. The operations of 1915 may be performed in accordance with examples as disclosed herein. In some aspects, aspects of the operations of 1915 may be performed by a report payload component 1255 as described with reference to FIG. 12.

The following provides an overview of aspects of the present disclosure:

Aspect 1: A method for wireless communication at a first network node, comprising: receiving, from a second network node, CSI report configuration information including a first set of one or more reference signal resource IDs, wherein each respective reference signal resource ID of the first set of one or more reference signal resource IDs corresponds to a respective reference signal resource for which respective measurement information is a candidate for inclusion in or is to be included in a report for transmission to the second network node; generating respective measurement information for each respective reference signal resource of a plurality of reference signal resources; and transmitting, to the second network node, the report, wherein the report includes, based on the CSI report configuration information, the respective measurement information corresponding to each respective reference signal resource of the plurality of reference signal resources that corresponds to each respective reference signal resource ID of a second set of one or more reference signal resource IDs, wherein the second set of one or more reference signal resource IDs is the first set of one or more reference signal resource IDs or is a subset of the first set of one or more reference signal resource IDs.

Aspect 2: The method of aspect 1, wherein the second set of one or more reference signal resource IDs is the subset of the first set of one or more reference signal resource IDs, wherein the first set of one or more reference signal resource IDs includes a first quantity of reference signal resource IDs and the second set of one or more reference signal resource IDs includes a second quantity of reference signal resource IDs, and wherein the first quantity is greater than the second quantity.

Aspect 3: The method of any of aspects 1 through 2, wherein receiving the CSI report configuration information, the at least one processor is configured to receiving the CSI report configuration information in RRC signaling, a MAC-CE, or DCI.

Aspect 4: The method of any of aspects 1 through 3, wherein the CSI report configuration information includes a CSI resource setting associated with a CSI report setting and a CSI resource set, and wherein the CSI resource setting includes the first set of one or more reference signal resource IDs.

Aspect 5: The method of any of aspects 1 through 4, wherein the report is a first report, and further comprising: transmitting a plurality of reports based on the CSI report configuration information, wherein the plurality of reports includes the first report, and wherein the second set of one or more reference signal resource IDs is different for each respective report of the plurality of reports.

Aspect 6: The method of any of aspects 1 through 5, wherein the second set of one or more reference signal resource IDs is the subset of the first set of one or more reference signal resource IDs, and further comprising: receiving, from the second network node, second CSI report configuration information indicative of the second set of one or more reference signal resource IDs from the first set of one or more reference signal resource IDs.

Aspect 7: The method of aspect 6, wherein receiving the second CSI report configuration information comprises: receiving the second CSI report configuration information in a MAC-CE or DCI.

Aspect 8: The method of any of aspects 1 through 7, wherein the second set of one or more reference signal resource IDs is the subset of the first set of one or more reference signal resource IDs, wherein the first set of one or more reference signal resource IDs includes a plurality of subsets of one or more reference signal resource IDs, and wherein the subset of the first set of one or more reference signal resource IDs is a first subset of the plurality of subsets.

Aspect 9: The method of aspect 8, wherein the first subset is based on a standard deviation of respective measurement information for each reference signal resource corresponding to each reference signal resource ID from the first subset.

Aspect 10: The method of any of aspects 8 through 9, wherein the first subset is based on an RSRP change rate, an SINR change rate, or any combination thereof.

Aspect 11: The method of any of aspects 8 through 10, wherein the report only includes measurement information for each respective reference signal resource of the plurality of reference signal resources that corresponds to each respective reference signal resource ID of the first subset.

Aspect 12: The method of any of aspects 1 through 11, wherein the respective measurement information included in the report includes a first measurement value corresponding to a first reference signal resource of the plurality of reference signal resources that corresponds to a first reference signal resource ID of the second set of one or more reference signal resource IDs, and one or more respective measurement values corresponding to other reference signal resources of the plurality of reference signal resources that corresponds to other reference signal resource IDs of the second set of one or more reference signal resource IDs, and wherein the one or more respective measurement values are included in the report in an order relative to the first reference signal resource ID.

Aspect 13: The method of aspect 12, wherein the first measurement value corresponds to a highest RSRP or SINR measurement.

Aspect 14: The method of any of aspects 12 through 13, wherein the order is in either an ascending reference signal resource ID order relative to the first reference signal resource ID or a descending reference signal resource ID order relative to the first reference signal resource ID.

Aspect 15: The method of any of aspects 1 through 14, wherein the report includes, independent of a quantity of reference signal resource IDs in the second set of one or more reference signal resource IDs, a quantity of bits to represent the respective measurement information for the reference signal resources that correspond to each reference signal resource in the second set of one or more reference signal resource IDs.

Aspect 16: The method of aspect 15, wherein a payload size of the report is based on the quantity of the reference signal resource IDs in the second set of one or more reference signal resource IDs.

Aspect 17: The method of aspect 16, wherein transmitting the report comprises: transmitting the report using one or more control channel resources or an MCS.

Aspect 18: The method of any of aspects 16 through 17, wherein the report includes a first portion and a second portion, wherein the first portion includes an indication of the second set of one or more reference signal resource IDs and the second portion includes the respective measurement information, and wherein the first portion is fixed in size and the second portion is variable in size.

Aspect 19: The method of any of aspects 1 through 18, wherein a quantity of bits used for a payload of the report is fixed independent of a quantity of the reference signal resource IDs of the second set of one or more reference signal resource IDs.

Aspect 20: The method of aspect 19, further comprising: determining a quantization granularity for inclusion of the respective measurement information in the report based on the quantity of bits and the quantity of the reference signal resource IDs of the second set of one or more reference signal resource IDs.

Aspect 21: The method of aspect 20, wherein, determining the quantization granularity comprises: receiving an indication of one or more of the quantity of bits or an association between the quantity of bits and the quantization granularity.

Aspect 22: The method of any of aspects 1 through 21, wherein the respective measurement information included in the report is organized in a plurality of groups, each group including a respective first reference signal resource ID of the second set of one or more reference signal resource IDs and the respective measurement information corresponding to other reference signal resource IDs of the second set of one or more reference signal resource IDs, the respective measurement information being included in the report in the plurality of groups either in an ascending reference signal resource ID order relative to the respective first reference signal resource ID or a descending reference signal resource ID order relative to the respective first reference signal resource ID.

Aspect 23: The method of aspect 22, wherein the groups corresponding to the second set of one or more reference signal resource IDs are based on the CSI report configuration information or an angular separation between the reference signal resources corresponding to the reference signal resource IDs in the second set of one or more reference signal resource IDs.

Aspect 24: The method of any of aspects 1 through 23, wherein the report includes a plurality of groups, wherein each respective group includes a respective subset of the second set of one or more reference signal resource IDs including a respective first reference signal resource ID and a respective second reference signal ID, wherein the respective measurement information corresponding to each respective first reference signal resource ID in each respective group is represented by a first quantity of bits, and wherein the respective measurement information corresponding to each respective second reference signal resource ID in each respective group is represented by a second quantity of bits different from the first quantity of bits.

Aspect 25: The method of aspect 24, wherein each respective group is included in the report either in an ascending reference signal resource ID order relative to the respective first reference signal resource ID or a descending reference signal resource ID order relative to the respective first reference signal resource ID.

Aspect 26: The method of any of aspects 1 through 25, wherein each respective reference signal resource of the one or more reference signal resources is either a CSI-reference signal resource or an SSB resource.

Aspect 27: A method for wireless communication at a first network node, comprising: transmitting, to a second network node, CSI report configuration information including a first set of one or more reference signal resource IDs, wherein each respective reference signal resource ID of the one or more reference signal resource IDs corresponds to a respective reference signal resource for which respective measurement information is a candidate for inclusion in or is to be included in a report for transmission to the second network node; transmitting a plurality of reference signals using the reference signal resources that correspond to the respective reference signal resource IDs of the first set of one or more reference signal resource IDs; and receiving, from the second network node, the report, wherein the report includes, based on the CSI report configuration information, the respective measurement information corresponding to each respective reference signal resource of the plurality of reference signal resources that corresponds to each respective reference signal resource ID of a second set of one or more reference signal resource IDs, wherein the second set of one or more reference signal resource IDS is the first set of one or more reference signal resource IDs or is a subset of the first set of one or more reference signal resource IDs.

Aspect 28: The method of aspect 27, wherein the second set of one or more reference signal resource IDs is the subset of the first set of one or more reference signal resource IDs, wherein the first set of one or more reference signal resource IDs includes a first quantity of reference signal resource IDs and the second set of one or more reference signal resource IDs includes a second quantity of reference signal resource IDs, and wherein the first quantity is greater than the second quantity.

Aspect 29: The method of aspect 28, wherein transmitting the CSI report configuration information comprises: transmitting the CSI report configuration information in RRC signaling, a MAC-CE, or DCI.

Aspect 30: The method of any of aspects 28 through 29, wherein the report is a first report, and further comprising: receiving a plurality of reports based on the CSI report configuration information, wherein the plurality of reports includes the first report, and wherein the second set of one or more reference signal resource IDs is different for each respective report of the plurality of reports.

Aspect 31: The method of any of aspects 27 through 30, wherein the CSI report configuration information includes a CSI resource setting associated with a CSI report setting and a CSI resource set, and wherein the CSI resource setting includes the first set of one or more reference signal resource IDs.

Aspect 32: The method of any of aspects 27 through 31, wherein the second set of one or more reference signal resource IDs is the subset of the first set of one or more reference signal resource IDs, and further comprising: transmitting, to the second network node, second CSI report configuration information indicative of the second set of one or more reference signal resource IDS from the first set of one or more reference signal resource IDs.

Aspect 33: The method of aspect 32, wherein transmitting the second CSI report configuration information comprises: transmitting the second CSI report configuration information in a MAC-CE or DCI.

Aspect 34: The method of any of aspects 27 through 33, wherein the second set of one or more reference signal resource IDs is the subset of the first set of one or more reference signal resource IDs, wherein the first set of one or more reference signal resource IDs includes a plurality of subsets of one or more reference signal resource IDs, and wherein the subset of the first set of one or more reference signal resource IDs is a first subset of the plurality of subsets.

Aspect 35: The method of aspect 34, wherein the report includes an indication of the first subset.

Aspect 36: The method of any of aspects 34 through 35, wherein the first subset of one or more reference signal resource IDs is based on a standard deviation of respective measurement information for each reference signal resource corresponding to each reference signal resource ID from the first subset.

Aspect 37: The method of any of aspects 34 through 36, wherein the first subset is based on an RSRP change rate, an SINR change rate, or any combination thereof.

Aspect 38: The method of any of aspects 34 through 37, wherein the report only includes measurement information for each respective reference signal resource of the plurality of reference signal resources that corresponds to each respective reference signal resource ID of the first subset.

Aspect 39: The method of any of aspects 27 through 38, wherein the respective measurement information included in the report includes a first measurement value corresponding to a first reference signal resource of the plurality of reference signal resources that corresponds to a first reference signal resource ID of the second set of one or more reference signal resource IDs, and one or more respective measurement values corresponding to other reference signal resources of the plurality of reference signal resources that corresponds to a first reference signal resource ID of the second set of one or more reference signal resource IDs, and wherein the one or more respective measurement values are included in the report in an order relative to the first reference signal resource ID.

Aspect 40: The method of aspect 39, wherein the first measurement value corresponds to a highest RSRP or SINR measurement.

Aspect 41: The method of any of aspects 39 through 40, wherein the order is in either an ascending reference signal resource ID order relative to the first reference signal resource ID or a descending reference signal resource ID order relative to the first reference signal resource ID.

Aspect 42: The method of any of aspects 27 through 41, wherein the report includes, independent of a quantity of reference signal resource IDs in the second set of one or more reference signal resource IDs, a quantity of bits that represents the respective measurement information for the reference signal resources that correspond to each reference signal resource in the second set of one or more reference signal resource IDs.

Aspect 43: The method of aspect 42, wherein a payload size of the report is based on the quantity of the reference signal resource IDs in the second set of one or more reference signal resource IDs.

Aspect 44: The method of aspect 43, wherein receiving the report comprises: receiving the report using one or more control channel resources or an MCS.

Aspect 45: The method of any of aspects 43 through 44, wherein the report includes a first portion and a second portion of the report, wherein the first portion includes an indication of the second set of one or more reference signal resource IDs and the second portion includes the respective measurement information, and wherein the first portion is fixed in size and the second portion is variable in size.

Aspect 46: The method of any of aspects 27 through 45, wherein a quantity of bits used for a payload of the report is fixed independent of a quantity of the reference signal resource IDS of the second set of one or more reference signal resource IDs.

Aspect 47: The method of aspect 46, further comprising: transmitting an indication of one or more of the quantity of bits or an association between the quantity of bits and a quantization granularity.

Aspect 48: The method of any of aspects 27 through 47, wherein the respective measurement information included in the report is organized in a plurality of groups, each group including a respective first reference signal resource ID of the second set of one or more reference signal resource IDs and the respective measurement information corresponding to other reference signal resource IDs of the second set of one or more reference signal resource IDs, the respective measurement information being included in the report in the plurality of groups either in an ascending reference signal resource ID order relative to the respective first reference signal resource ID or a descending reference signal resource ID order relative to the respective first reference signal resource ID.

Aspect 49: The method of aspect 48, wherein the groups corresponding to the second set of one or more reference signal resource IDs are based on the CSI report configuration information or an angular separation between the reference signal resources corresponding to the reference signal resource IDs in the second set of one or more reference signal resource IDs.

Aspect 50: The method of any of aspects 27 through 49, wherein the report includes a plurality of groups, wherein each respective group includes a respective subset of the second set of one or more reference signal resource IDs including a respective first reference signal resource ID and a respective second reference signal ID, wherein the respective measurement information corresponding to each respective first reference signal resource ID in each respective group is represented by a first quantity of bits, and wherein the respective measurement information corresponding to each respective second reference signal resource ID in each respective group is represented by a second quantity of bits different from the first quantity of bits.

Aspect 51: The method of aspect 50, wherein each respective group is included in the report either in an ascending reference signal resource ID order relative to the respective first reference signal resource ID or a descending reference signal resource ID order relative to the respective first reference signal resource ID.

Aspect 52: The method of any of aspects 27 through 51, wherein each respective reference signal resource of the one or more reference signal resources is either a CSI-reference signal resource or an SBB resource.

Aspect 53: A first network node for wireless communication, comprising a memory; and at least one processor coupled to the memory, wherein the at least one processor is configured to perform a method of any of aspects 1 through 26.

Aspect 54: A first network node for wireless communication, comprising at least one means for performing a method of any of aspects 1 through 26.

Aspect 55: A non-transitory computer-readable medium having code for wireless communication stored thereon that, when executed by a first network node, causes the first network node to perform a method of any of aspects 1 through 26.

Aspect 56: A first network node for wireless communication, comprising a memory; and at least one processor coupled to the memory, wherein the at least one processor is configured to perform a method of any of aspects 27 through 52.

Aspect 57: An first network node for wireless communication, comprising at least one means for performing a method of any of aspects 27 through 52.

Aspect 58: A non-transitory computer-readable medium having code for wireless communication stored thereon that, when executed by a first network node, causes the first network node to perform a method of any of aspects 27 through 52.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network node for wireless communication, comprising:
a memory; and
at least one processor coupled to the memory, wherein the at least one processor is configured to:
receive, from a second network node, channel state information (CSI) report configuration information including a first set of one or more reference signal (RS) resource identifiers (IDs), wherein each respective RS resource ID of the first set of one or more RS resource IDs corresponds to a respective RS resource for which respective measurement information is a candidate for inclusion in or is to be included in a report for transmission to the second network node;
generate respective measurement information for each respective RS resource of a plurality of RS resources; and
transmit, to the second network node, the report, wherein the report includes, based on the CSI report configuration information, the respective measurement information corresponding to each respective RS resource of the plurality of RS resources that corresponds to each respective RS resource ID of a second set of one or more RS resource IDs, wherein the second set of one or more RS resource IDs is the first set of one or more RS resource IDs or is a subset of the first set of one or more RS resource IDs.

2. The first network node of claim 1, wherein:
the second set of one or more RS resource IDs is the subset of the first set of one or more RS resource IDs,
the first set of one or more RS resource IDs includes a first quantity of RS resource IDs and the second set of one or more RS resource IDs includes a second quantity of RS resource IDs, and
the first quantity is greater than the second quantity.

3. The first network node of claim 1, wherein, to receive the CSI report configuration information, the at least one processor is configured to:
receive the CSI report configuration information in radio resource control (RRC) signaling, a media access control (MAC) control element (CE) (MAC-CE), or downlink control information (DCI).

4. The first network node of claim 1, wherein:
the CSI report configuration information includes a CSI resource setting associated with a CSI report setting and a CSI resource set, and
the CSI resource setting includes the first set of one or more RS resource IDs.

5. The first network node of claim 1, wherein the report is a first report, and wherein the at least one processor is configured to:
transmit a plurality of reports based on the CSI report configuration information, wherein the plurality of reports includes the first report, and wherein the second set of one or more RS resource IDs is different for each respective report of the plurality of reports.

6. The first network node of claim 1, wherein the second set of one or more RS resource IDs is the subset of the first set of one or more RS resource IDs, and wherein the at least one processor is further configured to:
receive, from the second network node, second CSI report configuration information indicative of the second set of one or more RS resource IDs from the first set of one or more RS resource IDs.

7. The first network node of claim 6, wherein, to receive the second CSI report configuration information, the at least one processor is configured to:
receive the second CSI report configuration information in a MAC-CE or DCI.

8. The first network node of claim 1, wherein:
the second set of one or more RS resource IDs is the subset of the first set of one or more RS resource IDs,
the first set of one or more RS resource IDs includes a plurality of subsets of one or more RS resource IDs, and
the subset of the first set of one or more RS resource IDs is a first subset of the plurality of subsets.

9. The first network node of claim 8, wherein the report includes an indication of the first subset.

10. The first network node of claim 8, wherein the first subset is based on a standard deviation of respective measurement information for each RS resource corresponding to each RS resource ID from the first subset.

11. The first network node of claim 8, wherein the first subset is based on a reference signal received power change rate, a signal-interference-to-noise ratio change rate, or any combination thereof.

12. The first network node of claim 8, wherein the report only includes measurement information for each respective RS resource of the plurality of RS resources that corresponds to each respective RS resource ID of the first subset.

13. The first network node of claim 1, wherein:
the respective measurement information included in the report includes a first measurement value corresponding to a first RS resource of the plurality of RS resources that corresponds to a first RS resource ID of the second set of one or more RS resource IDs, and one or more respective measurement values corresponding to other RS resources of the plurality of RS resources that corresponds to other RS resource IDs of the second set of one or more RS resource IDs, and
the one or more respective measurement values are included in the report in an order relative to the first RS resource ID.

14. The first network node of claim 13, wherein the first measurement value corresponds to a highest reference signal received power or signal-interference-to-noise ratio measurement.

15. The first network node of claim 13, wherein the order is in either an ascending RS resource ID order relative to the first RS resource ID or a descending RS resource ID order relative to the first RS resource ID.

16. The first network node of claim 1, wherein the report includes, independent of a quantity of RS resource IDs in the second set of one or more RS resource IDs, a quantity of bits to represent the respective measurement information for the RS resources that correspond to each RS resource in the second set of one or more RS resource IDs.

17. The first network node of claim 16, wherein a payload size of the report is based on the quantity of the RS resource IDs in the second set of one or more RS resource IDs.

18. The first network node of claim 17, wherein, to transmit the report, the at least one processor is configured to:
transmit the report using one or more control channel resources or a modulation and coding scheme.

19. The first network node of claim 17, wherein:
the report includes a first portion and a second portion,
the first portion includes an indication of the second set of one or more RS resource IDs and the second portion includes the respective measurement information, and
the first portion is fixed in size and the second portion is variable in size.

20. The first network node of claim 1, wherein a quantity of bits used for a payload of the report is fixed independent of a quantity of the RS resource IDs of the second set of one or more RS resource IDs.

21. The first network node of claim 20, wherein the at least one processor is further configured to:
determine a quantization granularity for inclusion of the respective measurement information in the report based on the quantity of bits and the quantity of the RS resource IDs of the second set of one or more RS resource IDs.

22. The first network node of claim 21, wherein, to determine the quantization granularity, the at least one processor is further configured to:
receive an indication of one or more of the quantity of bits or an association between the quantity of bits and the quantization granularity.

23. A first network node for wireless communication, comprising:
a memory; and
at least one processor coupled to the memory, wherein the at least one processor is configured to:
transmit, to a second network node, channel state information (CSI) report configuration information including a first set of one or more reference signal (RS) resource identifiers (IDs), wherein each respective RS resource ID of the one or more RS resource IDs corresponds to a respective RS resource for which respective measurement information is a candidate for inclusion in or is to be included in a report for transmission to the second network node;
transmit a plurality of RSs using the RS resources that correspond to the respective RS resource IDs of the first set of one or more RS resource IDs; and
receive, from the second network node, the report, wherein the report includes, based on the CSI report configuration information, the respective measurement information corresponding to each respective RS resource of the plurality of RS resources that corresponds to each respective RS resource ID of a second set of one or more RS resource IDs, wherein the second set of one or more RS resource IDS is the first set of one or more RS resource IDs or is a subset of the first set of one or more RS resource IDs.

24. The first network node of claim 23, wherein:
the second set of one or more RS resource IDs is the subset of the first set of one or more RS resource IDs,
the first set of one or more RS resource IDs includes a first quantity of RS resource IDs and the second set of one or more RS resource IDs includes a second quantity of RS resource IDs, and
the first quantity is greater than the second quantity.

25. The first network node of claim 24, wherein, to transmit the CSI report configuration information, the at least one processor is further configured to:
transmit the CSI report configuration information in radio resource control (RRC) signaling, a media access control (MAC) control element (CE) (MAC-CE), or downlink control information (DCI).

26. The first network node of claim 24, wherein the report is a first report, and wherein the at least one processor is configured to:
transmit a plurality of reports based on the CSI report configuration information, wherein the plurality of reports includes the first report, and wherein the second set of one or more RS resource IDs is different for each respective report of the plurality of reports.

27. The first network node of claim 23, wherein:
the CSI report configuration information includes a CSI resource setting associated with a CSI report setting and a CSI resource set, and
the CSI resource setting includes the first set of one or more RS resource IDs.

28. The first network node of claim 23, wherein the second set of one or more RS resource IDs is the subset of the first set of one or more RS resource IDs, and wherein the at least one processor is further configured to:
transmit, to the second network node, second CSI report configuration information indicative of the second set of one or more RS resource IDS from the first set of one or more RS resource IDs.

29. A method for wireless communication at a first network node, comprising:
receiving, from a second network node, channel state information (CSI) report configuration information including a first set of one or more reference signal (RS) resource identifiers (IDs), wherein each respective RS resource ID of the first set of one or more RS resource IDs corresponds to a respective RS resource for which respective measurement information is a candidate for inclusion in or is to be included in a report for transmission to the second network node;
generating respective measurement information for each respective RS resource of a plurality of RS resources; and
transmitting, to the second network node, the report, wherein the report includes, based on the CSI report configuration information, the respective measurement information corresponding to each respective RS resource of the plurality of RS resources that corresponds to each respective RS resource ID of a second set of one or more RS resource IDs, wherein the second set of one or more RS resource IDs is the first set of one or more RS resource IDs or is a subset of the first set of one or more RS resource IDs.

30. A method for wireless communication at a first network node, comprising:
transmitting, to a second network node, channel state information (CSI) report configuration information including a first set of one or more reference signal (RS) resource identifiers (IDs), wherein each respective RS resource ID of the one or more RS resource IDs corresponds to a respective RS resource for which respective measurement information is a candidate for inclusion in or is to be included in a report for transmission to the second network node;
transmitting a plurality of RSs using the RS resources that correspond to the respective RS resource IDs of the first set of one or more RS resource IDs; and
receiving, from the second network node, the report, wherein the report includes, based on the CSI report configuration information, the respective measurement information corresponding to each respective RS resource of the plurality of RS resources that corresponds to each respective RS resource ID of a second set of one or more RS resource IDs, wherein the second set of one or more RS resource IDS is the first set of one or more RS resource IDs or is a subset of the first set of one or more RS resource IDs.
